(19) United States
(12) Patent Application Publication
(10) Pub. No.: US 2025/0112481 A1
(43) Pub. Date: Apr. 3, 2025

(54) METHODS AND APPARATUS FOR ISOLATED TRANSMITTERS

(71) Applicant: Texas Instruments Incorporated, Dallas, TX (US)

(72) Inventors: Lei Chen, McKinney, TX (US); Vishnu Ravinuthula, Dallas, TX (US); Siang Tong Tan, Dallas, TX (US); Chienyu Huang, Plano, TX (US); Richard Sterling Broughton, Dallas, TX (US)

(21) Appl. No.: 18/620,785

(22) Filed: Mar. 28, 2024

Related U.S. Application Data
(60) Provisional application No. 63/541,475, filed on Sep. 29, 2023.

(51) Int. Cl. H02J 7/00; B60L 50/60

(52) U.S. Cl. CPC H02J 7/0063; B60L 50/66; H02J 2207/10

(57) ABSTRACT

An example system includes: a first device having a ground plane at a first voltage, a first transmission terminal, and a second transmission terminal; a second device having a ground plane at a second voltage, a first receiver terminal, and a second receiver terminal; wherein the first device is configured to: operate in either a linear mode or a saturation mode based on a magnitude of electromagnetic interference; and during the linear mode or the saturation mode, use the first transmission terminal and second transmission terminal to transmit a differential signal to the second device.

### CROSS-REFERENCE TO RELATED APPLICATION

This patent application claims the benefit of and priority to U.S. Provisional Patent Application No. 63/541,475 filed Sep. 29, 2023, which Application is hereby incorporated herein by reference in its entirety.

### TECHNICAL FIELD

This description relates generally to transmitters and, more particularly, to methods and apparatus for isolated transmitters.

### BACKGROUND

Hybrid electric vehicles (HEVs) and electric vehicles (EVs) are powered by battery systems including batteries such as lithium-ion batteries. Battery systems may also include a battery management system to monitor the health of the batteries and report the health to a main electronic control unit (ECU) of the HEVs or EVs. The frequency, content, format, amount of data, and other characteristics of communications within a battery management system may vary due to a wide range of factors.

### SUMMARY

For methods and apparatus for isolated transmitters, an example system includes a first device having a ground plane at a first voltage, a first transmission terminal, and a second transmission terminal; a second device having a ground plane at a second voltage, a first receiver terminal, and a second receiver terminal; wherein the first device is configured to: operate in either a linear mode or a saturation mode based on a magnitude of electromagnetic interference; and during the linear mode or the saturation mode, use the first transmission terminal and second transmission terminal to transmit a differential signal to the second device.

### BRIEF DESCRIPTION OF THE DRAWINGS

FIG. 1 is a block diagram of an example automotive environment which includes battery circuitry that communicates over a Controller Area Network (CAN) bus.

FIG. 2 is a block diagram of an example implementation of the battery monitor circuitry of FIG. 1.

FIG. 3 is a block diagram of an example implementation of the battery module printed circuit board (PCB) of FIG. 2.

FIG. 4 is an example implementation of the transmitter circuitry of FIG. 3.

FIGS. 5A and 5B are an illustrative example of the transmitter circuitry of FIG. 3 operating in linear mode.

FIG. 6 is a first example graph illustrating the performance of the transmitter circuitry when operating in linear mode.

FIG. 7 is an example graph illustrating the output of the transmitter circuitry when operating in linear or mode.

FIGS. 8A, 8B, 8C, and 8D are an illustrative example of the transmitter circuitry of FIG. 3 operating in saturation mode.

FIG. 9 is an example graph illustrating the performance of the transmitter circuitry when operating in saturation mode.

FIG. 10 is an example graph illustrating the transmitter circuitry when operating in saturation mode during low frequency bulk current injection (BCI) conditions.

FIG. 11 is an example implementation of the common mode buffer of the transmitter circuitry of FIG. 3.

FIG. 12 is an example graph of the output of a transmitter circuit without a diode pair when operating in saturation mode during high frequency BCI conditions.

FIG. 13 is an example graph of the transmitter circuitry, which includes a diode pair, when operating in saturation mode during high frequency BCI conditions.

FIG. 14 is a flowchart representative of example machine-readable instructions and/or example operations that may be executed, instantiated, and/or performed using an example programmable circuitry implementation of the transmitter circuitry of FIG. 3.

FIG. 15 is a block diagram of an example processing platform including programmable circuitry structured to execute, instantiate, and/or perform the example machine-readable instructions and/or perform the example operations of FIG. 14 to implement the control circuitry 302 and transmitter circuitry 306 of FIG. 3.

The same reference numbers or other reference designators are used in the drawings to designate the same or similar (functionally and/or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

An HEV or an EV includes a system of multiple distributed batteries enabling an increased amp-hour capacity than would otherwise be attainable with a single battery. The increased amp-hour capacity improves the functionality of the system (e.g., increased range, torque, or speed of the vehicle, etc.) compared to single battery alternatives. In some implementations of multiple distributed batteries, one or more individual batteries connect to a controller that coordinates operations at a system-level. In some examples, the individual battery cells and/or the circuits coupled to the battery cells may be called battery modules, secondary batteries, secondary nodes, secondary network nodes, secondary circuits, monitor circuits, etc. Similarly, the controller may be called a battery controller, a primary node, a primary network node, a primary controller, etc.

The multiple distributed batteries are monitored by multiple electronic devices that communicate with one another. Automotive manufacturers and designers look for a variety of characteristics when selecting such an electronic device for use in a battery management system. For example, the use of shared communication buses in many battery management systems drives a desire for transmitter devices to be galvanically isolated from one another. As used herein, an isolated transmitter refers to a transmitter device that can prevent and/or mitigate the effects of noise between independent electrical systems, thereby improving both safety and performance.

In many examples, the large number of electronic systems within modern automobiles and proximity of those systems to one another can lead to the generation of electromagnetic noise. Such noise can be modeled using Bulk Current Injection (BCI), which is the injection of an unwanted amount of current into an electrical system. Therefore, transmitter devices that can survive comparatively high levels of BCI support a wider variety of applications than transmitter devices that can only survive comparatively low levels of BCI.

The wide variety of applications in which battery management systems are used include some applications where devices communicate using Alternating Current (AC) coupling interface and some applications where devices communicate using Direct Current (DC) coupling interface. Therefore, a transmitter device that can send signals using both AC and DC coupling can support a wider variety of applications than a transmitter device that only sends signals using one of the two types of coupling interfaces.

Some transmitter devices use a full H-bridge architecture to galvanically isolate the circuit from other electrical systems. However, such a transmitter device may operate with transistors that remain in linear mode during operation mode. Such a transmitter device does not survive high amounts of BCI and may accumulate error in a manner that shifts the Common Mode Voltage (V_CM) of the transmitter device over time. Communication devices with differential signals generally perform operations based on the presumption that the total voltage on either of the two signals is within a predefined range. Shifts in V_CM due to electromagnetic interference (EMI) may cause the total voltage on one or both inputs to exit the predefined range. EMI may be represented as BCI injected into a neighboring device, thereby negatively impacting performance throughout a battery management system. Furthermore, such full H-bridge transmitter devices with only a linear mode of transistor operation can transmit using an AC coupling but are unable to transmit using a DC coupling. Linear mode refers to when a transistor is biased such that the change to voltage across the transistor and the change to current flowing through the transistor are related to one another through a linear equation.

In DC coupled applications, some transmitter devices use a half-H bridge architecture to switch between two modes of operation, where the first mode is used because the amount of BCI from environmental noise is relatively low and the second mode is used because the amount of BCI is relatively high. However, the half-H bridge architecture prevents such transmitter devices from connecting to AC coupled communication buses. The lack of AC coupling prevents the transmitter device from being galvanically isolated, so such a transmitter can only connect to other devices that share a common DC voltage across their ground planes. Furthermore, such a transmitter device is designed for a robust environment composed of other electrical systems that can survive high amounts of BCI. Therefore, the transmitter device may be implemented with comparatively imprecise components that allow a comparatively large shift in V_CM. While the use of such imprecise components may decrease cost, they may prevent the use of the transmitter device in designed for less robust environments that require comparatively small shifts in V_CM.

Example methods, apparatus, and systems described herein describe a transmitter device that is galvanically isolated, can survive high amounts of BCI, and can transmit signals using both AC and DC. Example transmitter circuitry described herein uses a full H-bridge architecture that can operate in either a linear or a saturation mode. Saturation mode refers to when the transistor is biased such that the voltage across the transistor increases rapidly with minimal change to the magnitude of current flowing through the transistor. When environmental conditions provide relatively low amounts of BCI, transistors within the transmitter circuitry operate in a linear mode such that a differential signal is transmitted using Manchester Encoding. During periods with relatively high amounts of BCI, certain transistors within the transmitter circuitry operate in a saturation mode (and cause current to flow in a different configuration than when in linear mode) such that differential signaling and Manchester Encoding are still supported. High magnitude BCI may occur at any frequency. Accordingly, the example transmitter circuitry includes a buffer circuitry to counteract gradual shifts to V_CM that occur when environmental conditions cause BCI with relatively large magnitude but low frequency. The transmitter circuitry also includes diode pairs to prevent misshaped waveforms that can occur due to BCI with relatively large magnitude and high frequency. As a result, the transmitter circuitry described herein can support a wider variety of applications than other transmitter devices.

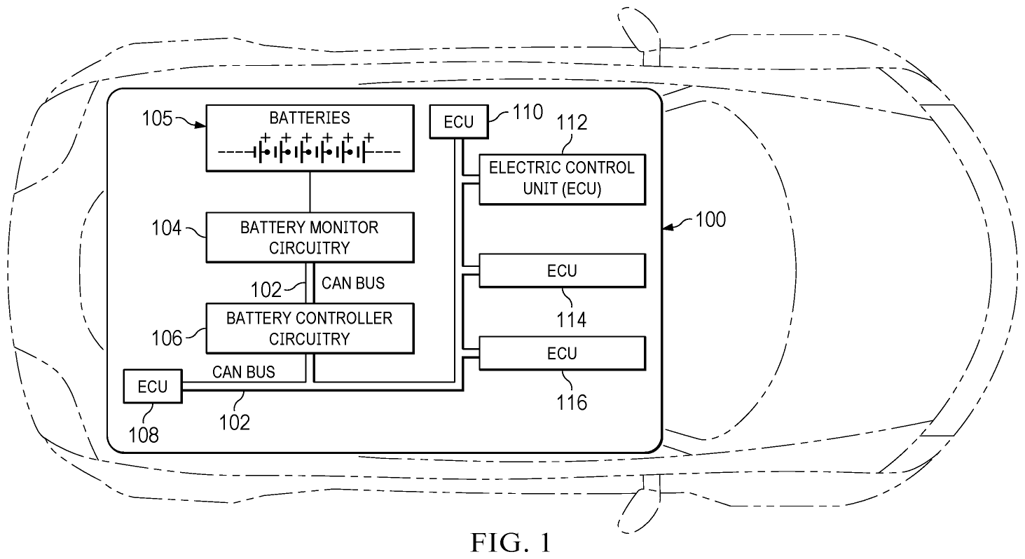

FIG. 1 is a block diagram of an example automotive environment. FIG. 1 shows an example vehicle 100. The vehicle 100 includes an example CAN bus 102, example battery monitor circuitry 104, example batteries 105, example battery controller circuitry 106, and other Electronic Control Units (ECUs) 108, 110, 112, 114, and 116. As used herein, the battery monitor circuitry 104, the battery controller circuitry 106, and the other ECUs 108-116 may be collectively referred to as the ECUs of FIG. 1.

The vehicle 100 of FIG. 1 is any vehicle that includes a CAN bus 102 and a power train that can connect to a battery. The vehicle 100 includes multiple systems which provide various functionalities. Example vehicle systems include but are not limited to the suspension, brakes, air conditioning, instrument panels, seat modules, transmission, batteries, engine, etc.

The CAN bus 102 is a wiring system that connects the ECUs of FIG. 1 to one another using the CAN standard. The use of the CAN bus 102 provides a uniform method for the ECUs of FIG. 1 to share information and simplify the wiring required to enable said information sharing. As a result, the CAN bus 102 is used in a wide variety of vehicles and vehicle systems.

The ECUs of FIG. 1 collectively control the various systems within the vehicle 100. An ECU 110 may control a vehicle system by receiving information from another ECU 112 over the CAN bus 102 and causing an action to occur in the vehicle system based on the received information. For example, an ECU 110 that controls a power source may transmit rotational speed or torque information over the CAN bus 102. The information may be received over the CAN bus 102 by an ECU 112 that controls a transmission. Based on the received rotational speed or torque information, the ECU 112 may send a signal to the transmission to shift gears. In some examples, the vehicle 100 may contain a different number of ECUs than shown in FIG. 1.

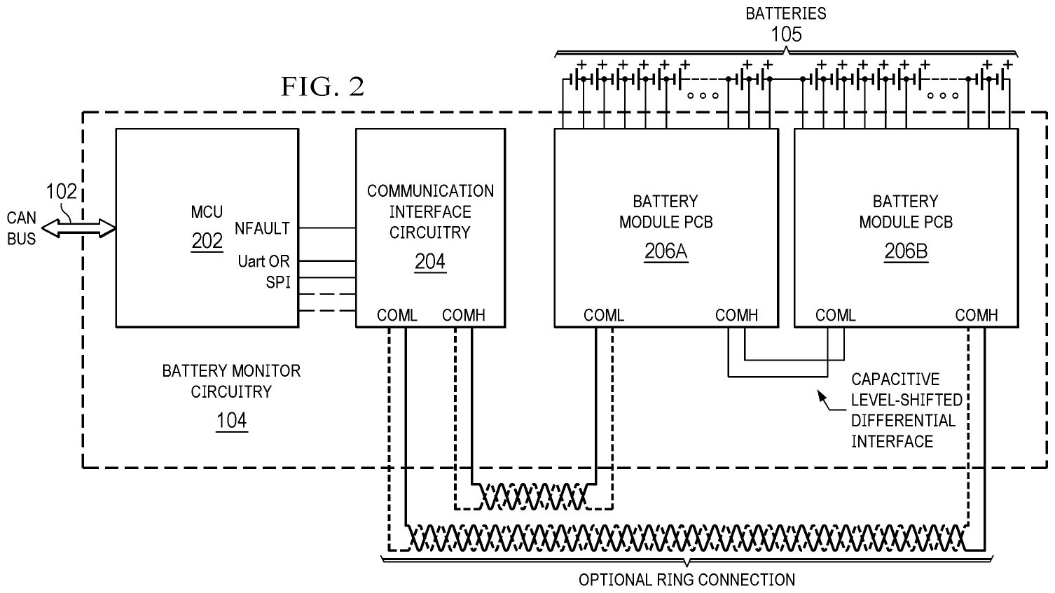

The battery monitor circuitry 104 is a type of ECU that monitors and communicates directly with the batteries 105. The battery monitor circuitry 104 may obtain any type of information from the batteries 105, including but not limited to cell voltages, cell amperage, temperature, error codes, etc. The battery monitor circuitry 104 is described further in connection with FIG. 2.

The battery controller circuitry 106 is a type of ECU that uses one or more signals from the battery monitor circuitry 104 and the other ECUs 108-116 to control the batteries 105. For example, the battery controller circuitry 106 may determine how many batteries connect to the power train at a given time, cause the batteries 105 to provide supply voltages for one or vehicle systems, etc. The battery controller circuitry 106 controls the batteries 105 by communicating with the battery monitor circuitry 104 via the CAN bus 102. In some examples, the battery monitor circuitry 104 and battery controller circuitry 106 may be collectively referred to as a battery management unit.

FIG. 2 is a block diagram of an example implementation of the battery monitor circuitry of FIG. 1. FIG. 2 includes the battery monitor circuitry 104 and the batteries 105. The battery monitor circuitry 104 includes an example Microprocessor Control Unit (MCU) 202, example communication interface circuitry 204, and example battery module printed circuit boards (PCBs) 206A and 206B (which may be collectively referred to herein as battery module PCBs 206). In some examples, the battery monitor circuitry 104 also includes balance and filter components connected to the batteries 105.

The MCU 202 manages the operations of the other components within the battery monitor circuitry 104. For example, the MCU 202 may cause the battery module PCBs 206 to periodically measure certain parameters of the batteries 105. The MCU 202 may then forward one or more of the parameters to other ECUs via the CAN bus 102, raise an error code if one or more of the parameters are outside of a pre-defined tolerance range, etc. In other examples, a different type of programmable circuitry manages the operations of other battery monitor components as described above. Examples of programmable circuitry include but are not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs).

The communication interface circuitry 204 enables the MCU 202 to communicate with the battery module PCBs 206. For example, the communication interface circuitry 204 may obtain data from the MCU 202 using a single-ended protocol such as Universal Asynchronous Receiver Transmitter (UART) or Serial Peripheral Interface (SPI). Such protocols can be used between the MCU 202 and the communication interface circuitry 204 because single-ended protocols are generally inexpensive to implement, and because the EMI produced by surrounding components is sufficiently low to support single-ended protocol.

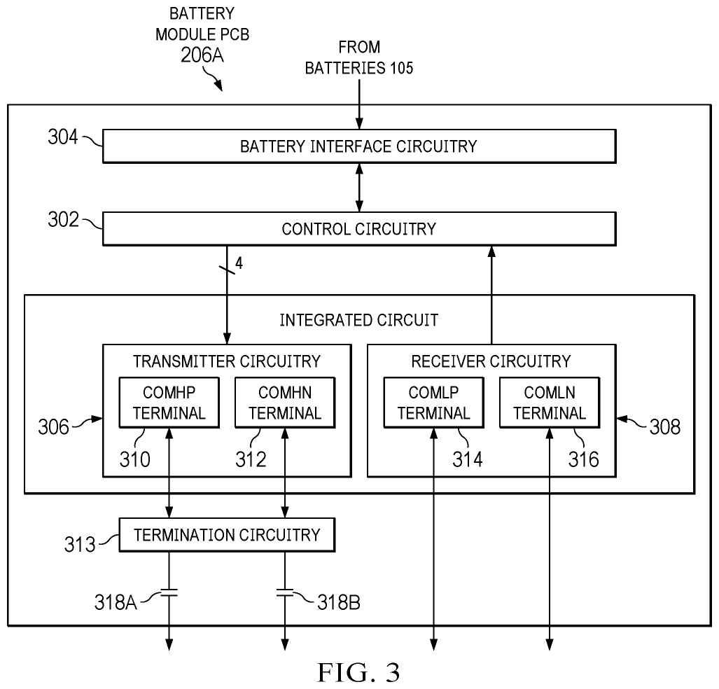

In contrast to the MCU 202 and communication interface circuitry 204, EMI generated from the batteries 105 could adversely impact the quality of communications sent and received by the battery module PCBs 206. As a result, the communication interface circuitry 204 and battery module PCBs 206 use a pair of Communication High (COMH) terminals that are interpreted together as a differential signal. Differential signaling is generally considered less susceptible to EMI than single-ended signaling. The communication interface circuitry 204 and battery module PCBs 206 also use a pair of Communication Low (COML) terminals as described further in connection with FIG. 3.

The battery module PCBs 206 obtain configuration parameters (e.g., cell voltage, temperature, etc.) from subsets of cells within the batteries 105. For example, the battery module PCB 206A may monitor the batteries between 0 Volts (V) and +100 V, while the battery module PCB 206B monitors the batteries between +100 V and +200 V. In some examples, the batteries 105 refer to hundreds of individual battery cells, and a given instance of the battery module PCB 206A connects to between 16 to 18 of the cells. On other examples, the number of cells in the batteries 105 is a different order of magnitude and/or a given instance of the battery module PCB connects to a different number of batteries. While FIG. 2 shows two battery module PCBs 206 for simplicity, other examples may include any number of battery module PCBs 206 based on the number of cells in the set of batteries 105.

Each of the battery module PCBs 206 obtains parameters that are to be communicated to the MCU 202 via the communication interface circuitry 204. However, because the battery module PCBs 206 are connected to mutually exclusive subsets of the batteries 105, they operate at different voltage domains. As a result, a non-isolated connection between the communication interface circuitry 204 and communication circuitry within the battery module PCB 206B could cause damage and unexpected behavior if the communication interface circuitry 204 is not rated to support the high voltage from the corresponding cells of the batteries 105. Therefore, the battery module PCBs 206 includes isolation circuitry and DC-isolated capacitors that separate communication circuitry (e.g., transmitter circuitry and receiver circuitry) within battery module PCB 206A from connecting directly to communication circuitry in battery module PCB 206B. The isolation circuitry and capacitors act as a barrier and prevent connected devices from experiencing the forgoing damage and unexpected behavior. The components also enable the battery module PCBs 206 to connect to one another with an AC coupling.

The battery module PCBs 206 and the communication interface circuitry 204 use the isolated and differential interface to communicate with one another in a bi-directional daisy chain configuration. That is, the battery module PCBs 206 connect to one another in series, and no more than two battery module PCBs 206 connect directly to the communication interface circuitry (the first instance of battery module PCB in series connects directly, and the last battery module PCB can optionally connect directly to form a closed loop). Such a configuration reduces the number of input/output (I/O) terminals used within the battery monitor circuitry 104, thereby making the battery monitor circuitry 104 less susceptible to loss of performance from BCI. The battery module PCB 206A is described further in connection with FIG. 3.

FIG. 3 is a block diagram of an example implementation of the battery module PCB of FIG. 2. The battery module PCB 206A of FIG. 3 may be instantiated (e.g., creating an instance of, bring into being for any length of time, materialize, implement, etc.) by programmable circuitry such as a Central Processor Unit (CPU) executing first instructions. The battery module PCB 206A of FIG. 3 may also be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. Some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers. The battery module PCB 206A includes example control circuitry 302, example battery interface circuitry 304, example transmitter circuitry 306, example receiver circuitry 308, an example COMH Positive (COMHP) terminal 310, an example COMH Negative (COMHN) terminal 312, an example COML Positive (COMLP) terminal 314, an example COML Negative (COMLN) terminal 316, example termination circuitry 313, and example capacitors 318A and 318B (which may be collectively referred to as capacitors 318).

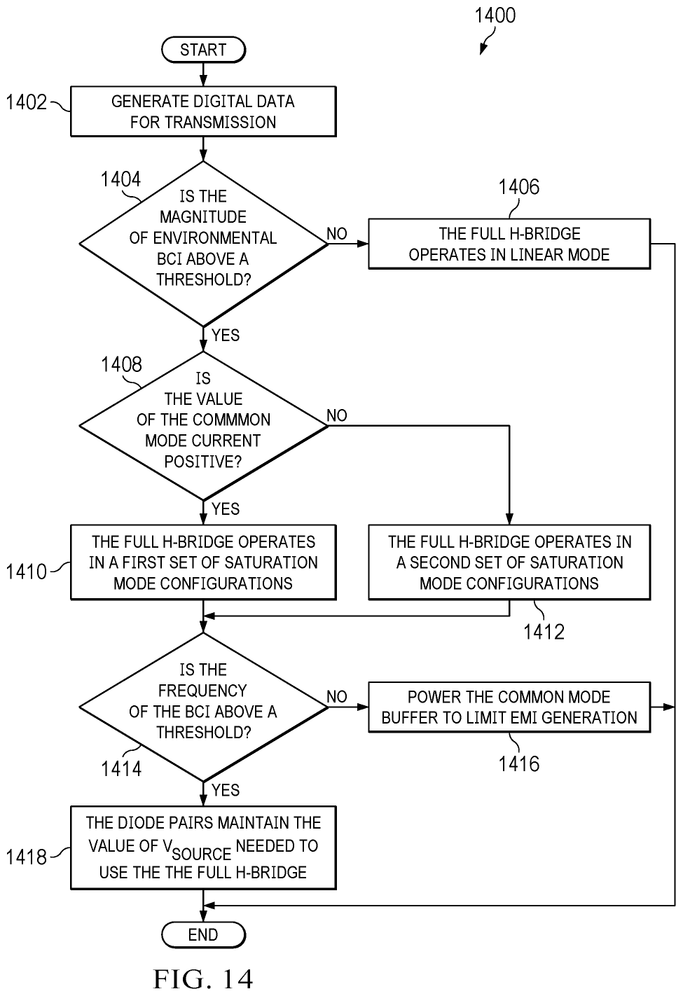

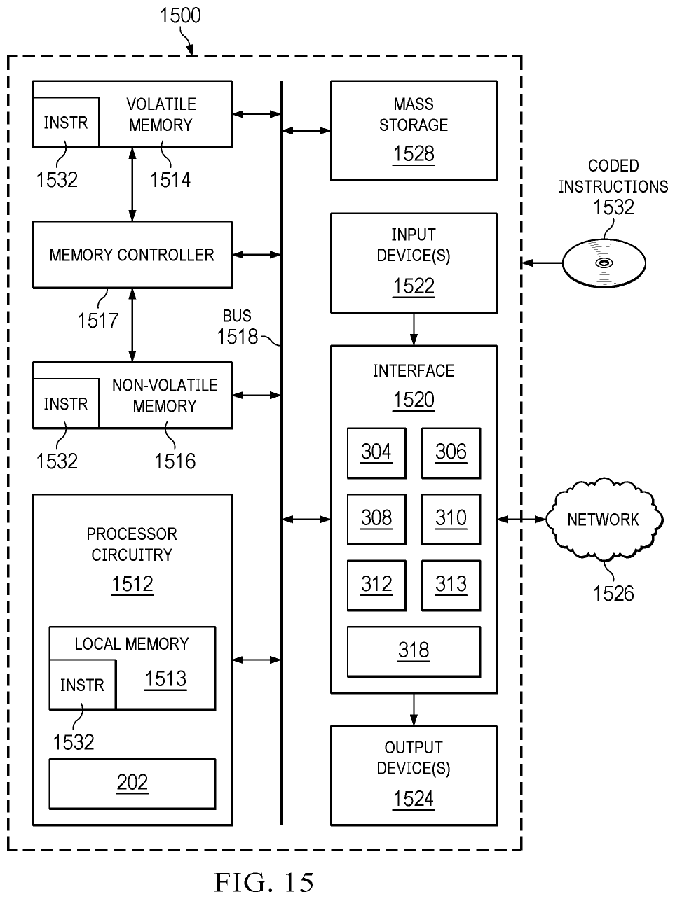

The control circuitry 302 manages the operations of other components within the battery module PCB 206A. For example, the control circuitry 302 may cause the battery interface circuitry 304 to obtain monitoring parameters from the batteries 105. The control circuitry 302 also forms outgoing signals that are intended for external devices (e.g., the communication interface circuitry 204, the battery module PCB 206B, etc.) and performs operations based on incoming signals received by said external devices. The control circuitry 302 may be implemented using any type of programmable circuitry. In some examples, the control circuitry 302 is instantiated by programmable circuitry executing control instructions and/or configured to perform operations such as those represented by the flowchart(s) of FIG. 14.

The example battery interface circuitry 304 obtains monitoring parameters including but not limited to cell voltage, cell amperage, and temperature from the batteries 105. The battery interface circuitry 304 may include any type of hardware components and perform any type of operations to obtain the monitoring parameters.

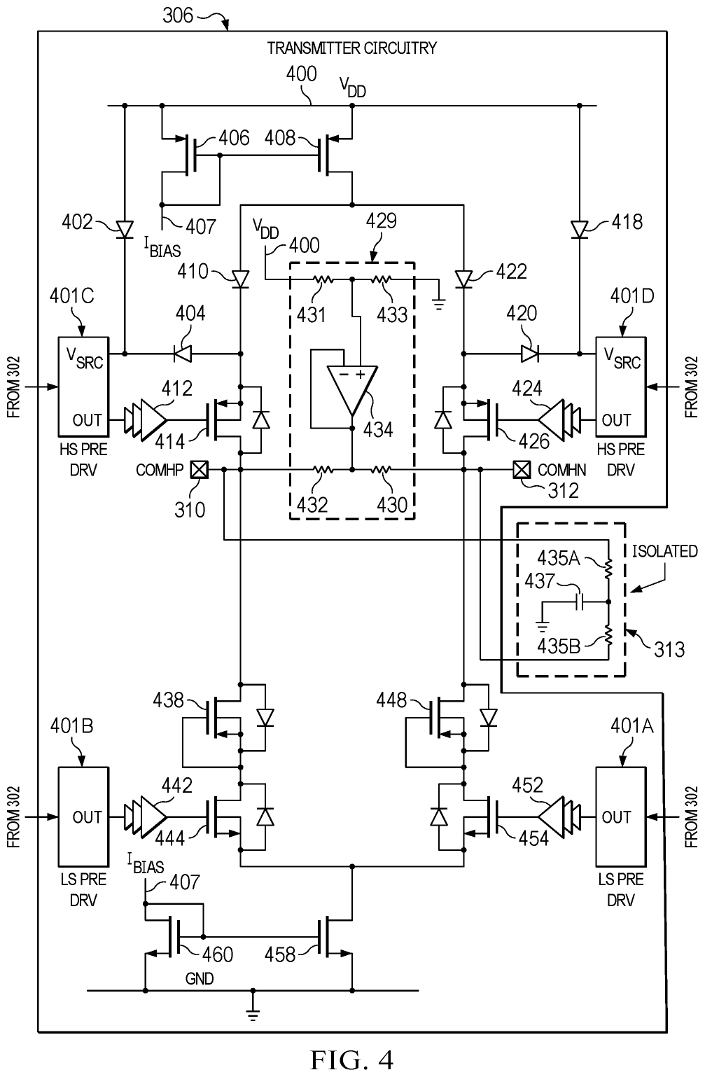

The transmitter circuitry 306 receives four signals from the control circuitry 302. The four signals collectively represent outgoing digital data (e.g., a sequence of logical bits intended for an external device). The transmitter circuitry 306 uses the four signals to modify the voltages of the COMHP terminal 310 and COMHN terminal 312 according to the teachings described herein. When received by an external device on the bi-directional daisy chain, the changes in voltages are collectively interpreted as a differential signal as described above. Notably, the transmitter circuitry 306 causes transmission of the differential signal in a manner that galvanically isolates the battery module PCB 206A from other devices, enables the battery module PCB 206A to survive high amounts of BCI from external devices, prevents V_CM from shifting away from a nominal value, and supports both AC and DC couplings. The transmitter circuitry 306 is described further in connection with FIGS. 4-14.

The receiver circuitry 308 monitors the voltages of the COMLP terminal 314 and the COMLN terminal 316 to obtain incoming signals. The receiver circuitry 308 may perform one or more signal conditioning operations to the incoming signals so that the underlying data is interpretable by the control circuitry 302. Such operations include but are not limited to analog to digital conversion, header removal, format conversion, error correction, etc.

In FIG. 2 and examples described herein, the transmitter circuitry 306 and the receiver circuitry 308 are implemented on an integrated circuit (IC) that is connected to but independent of the rest of the battery module PCB 206A. Accordingly, components within the termination circuitry 313 and the capacitors 318 may be referred to as external components because they are not implemented on the IC.

When the transmitter circuitry 306 generates an outgoing differential signal, current flows out of the COMHP terminal 310, through the termination circuitry 313, and through the capacitor 318A. In such examples, current also flows out of the COMHN terminal 312, through the termination circuitry 313, and through the capacitor 318B. The termination circuitry 313 helps maintain the galvanic isolation between the battery module PCBs 206 and prevents large shifts in V_CM. The termination circuitry 313 is described further in connection with FIG. 4.

The capacitors 318A and 318B of battery module PCB 206A connect directly to the COMLP terminal 314 and COMLN terminal 316 of battery module PCB 206B to form a linkage within the bi-directional daisy chain of FIG. 2. In some examples, the capacitors 318 are referred to as level shifted because the various capacitors store different amounts of charge based on the various voltage domains of cells within the batteries 105. In other examples, the capacitors 318 are referred to as DC-isolated capacitors.

FIG. 4 is an example implementation of the transmitter circuitry 306 and the termination circuitry 313 of FIG. 2. The transmitter circuitry 306 includes example pre-driver circuitry 401A, 401B, 401C, 401D (which may be collectively referred to as pre-driver circuits 401), example diodes 402, 404, 410, 418, 420, 422, example transistors 406, 408, 414, 426, 438, 444, 448, 454, 458, and 460, example driver circuitry 412, 424, 442, and 452, example resistors 430, 431, 432, 433, and example amplifier circuitry 434. The transmitter circuitry 306 also includes the COMHP terminal 310 and COMHN terminal 312 of FIG. 3, an example Volts Drain Drain (V_DD) terminal 400, an example current bias terminal 407 (which may be referred to herein as the I_bias terminal 407), and a ground terminal. The resistors 430, 431, 432, 433, and the amplifier circuitry 434 may be collectively referred to as buffer circuitry 429.

FIG. 4 also includes the termination circuitry 313, which includes an example resistor 435A, an example resistor 435B, and an example capacitor 437. In some examples, the resistor 435A or the 435B may be referred to as an external resistor (because the components are implemented externally from the IC that implements the transmitter circuitry 306) or a termination resistor (because they act as a terminal and connect to other components outside the battery module PCB 206A), as described above. Likewise, the capacitor 437 may be referred to as an external capacitor or a common-mode capacitor.

The V_DD terminal 400 of FIG. 4 is a supply terminal that is configured to receive a supply voltage from an external device (e.g., from power supply circuitry implemented within the vehicle 100). The supply voltage, which may be herein referred to as V_DD, is used by the transmitter circuitry to perform operations. For example, V_DD may be provided to a current terminal of one or more transistors such that voltages exhibited on the COMHP terminal 310 and COMHN terminal 312 can be collectively interpreted as a differential output signal.

The pre-driver circuits 401 include input terminals that receive signals from the control circuitry 302. The input signals indicate whether the pre-driver circuits 401 turn a corresponding transistor ON or OFF. For example, the pre-driver circuitry 401A causes the transistor 454 to turn ON or OFF based on a first signal from the control circuitry 302, the pre-driver circuitry 401B causes the transistor 444 to turn ON or OFF based on a second signal from the control circuitry 302, the pre-driver circuitry 401C causes the transistor 414 to turn on or OFF based ON a third signal from the control circuitry 302, and the pre-driver circuitry 401D causes the transistor 426 to turn ON or OFF based on a first signal from the control circuitry 302. Each of the pre-driver circuits 401 includes output terminals, while the pre-driver circuitry 401C and 401D include additional V_SRC terminals.

As used above and herein, a transistor being turned ON refers to a state where current is able to pass from a first current terminal, through the transistor, and to a second current terminal (where a current terminal refers to, for example, a source, a drain, a collector, emitter, etc.). Similarly, a transistor being turned OFF may refer to any state where current is unable to pass from the first current terminal to the second current terminal. In some examples, a transistor that is turned ON is referred to as conducting, enabled, etc. Similarly, a transistor that is turned OFF may be referred to as non-conducting, disabled, etc. In some examples, the pre-driver circuitry 401A and 401B are referred to as Low Side pre-driver circuits, while the pre-driver circuitry 401C and 401D are referred to as High Side pre-driver circuits.

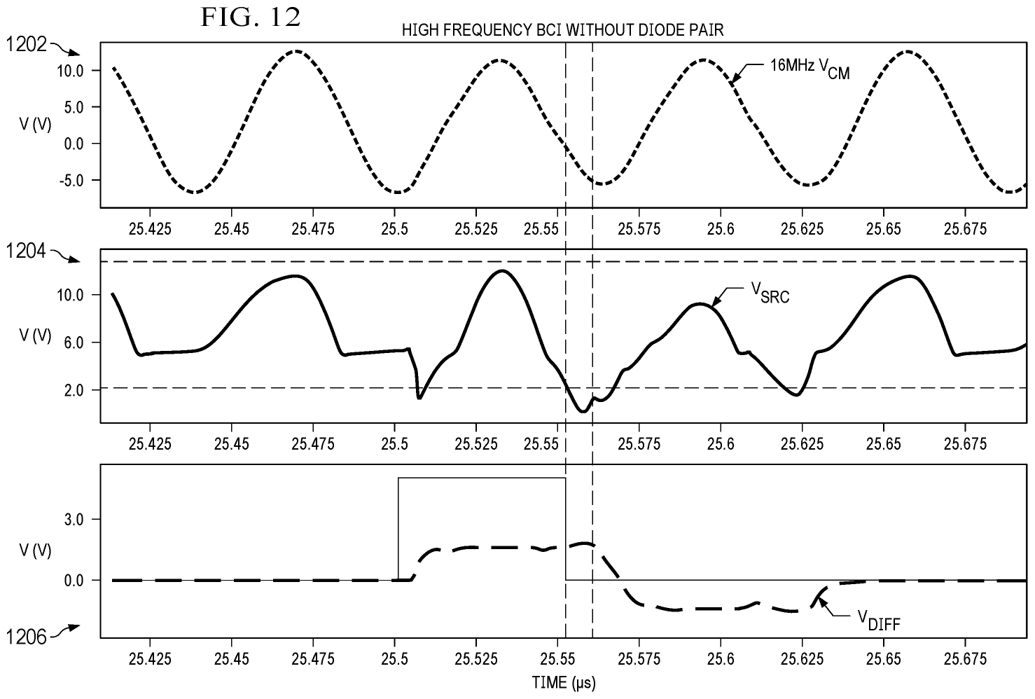

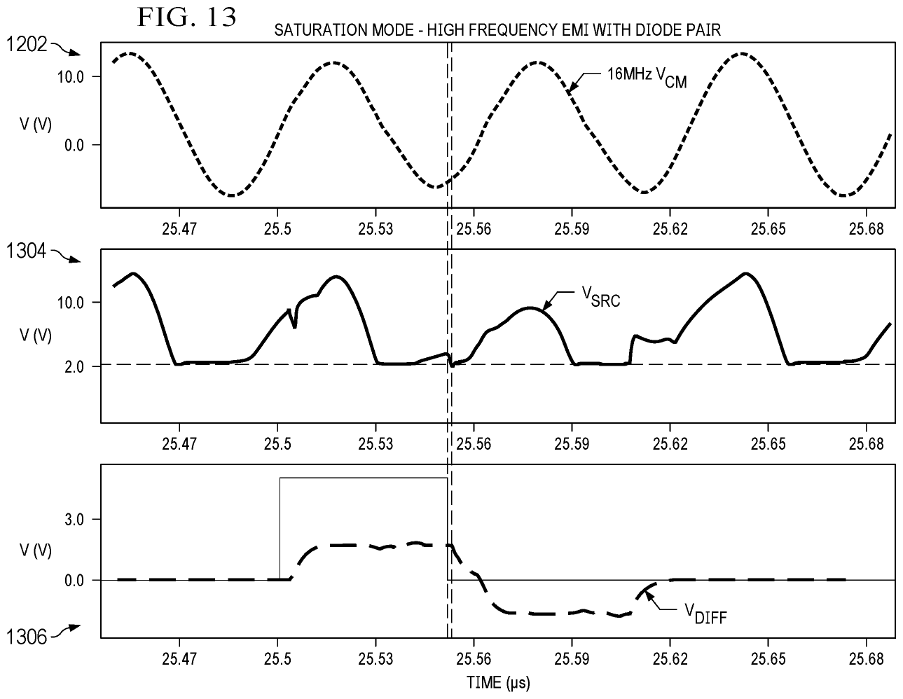

The diode 402 includes an anode coupled to the V_DD terminal 400 and a cathode coupled to the V_SRC terminal of the pre-driver circuitry 401C. The diode 404 includes a cathode coupled to the V_SRC terminal of the pre-driver circuitry 401C and an anode. The diodes 402 and 404 may be collectively referred to as a diode pair and are described further in connection with FIGS. 12 and 13.

The transistor 406 includes a source coupled to the V_DD terminal 400, a gate (e.g., a control terminal) coupled to the I_bias terminal 407, and a drain coupled to the I_bias terminal 407. The transistor 408 includes a source coupled to the V_DD terminal 400, a gate coupled to the gate of transistor 406 and the I_bias terminal 407, and a drain.

The diode 410 includes an anode coupled to the drain of the transistor 408 and a cathode. The driver circuitry 412 includes an input terminal coupled to the output terminal of the pre-driver circuitry 401C and an output terminal. The transistor 414 includes a source coupled to the anode of diode 404 and the cathode of diode 410, a gate coupled to the output terminal of the driver circuitry 412, and a drain coupled to the COMHP terminal 310. The structure of the transistor 414 also includes a body diode as shown in FIG. 4.

The diode 418 includes an anode coupled to the V_DD terminal 400 and a cathode coupled to the V_SRC terminal of the pre-driver circuitry 401D. The diode 420 includes a cathode coupled to the V_SRC terminal of the pre-driver circuitry 401D and an anode. The diodes 418 and 420 may be collectively referred to as a diode pair and are described further in connection with FIGS. 12 and 13.

The diode 422 includes an anode coupled to the drain of the transistor 408 and a cathode. The driver circuitry 424 includes an input terminal coupled to the output terminal of the pre-driver circuitry 401D and an output terminal. The transistor 426 includes a source coupled to the anode of diode 420 and the cathode of diode 422, a gate coupled to the output terminal of the driver circuitry 424, and a drain coupled to the COMHN terminal 312. The structure of the transistor 426 also includes a body diode as shown in FIG. 4.

Within the buffer circuitry 429, the resistor 431 includes a first terminal coupled to the V_DD terminal 400 and a second terminal. The resistor 433 includes a first terminal coupled to the second terminal of resistor 431 and a second terminal coupled to ground. The amplifier circuitry 434 includes a positive terminal coupled to the second terminal of the resistor 431 and the first terminal of the resistor 433. The amplifier circuitry 434 also includes a negative terminal and an output terminal that are coupled to one another. The resistor 430 includes a first terminal coupled to the COMHN terminal 312 and a second terminal coupled to the output terminal of the amplifier circuitry 434. The resistor 432 includes a first terminal coupled to the COMHP terminal 310 and a second terminal coupled to the output terminal of the amplifier circuitry 434.

Within the termination circuitry 313, the resistor 435A includes a first terminal coupled to the COMHP terminal 310 and a second terminal. The resistor 435B includes a first terminal coupled to the second terminal of the resistor 435A and a second terminal coupled to the COMHN terminal 312. In examples described herein, the resistors 435A and 435B have the same resistance value. In other examples, the resistor 435A has a different resistance value than resistor 435B.

The capacitor 437 includes a positive terminal coupled to the second terminal of the resistor 435A and the first terminal of resistor 435B. The capacitor 437 also includes a second terminal coupled to the ground terminal.

The transistor 438 includes a drain coupled to the COMHP terminal 310. The transistor 438 also includes a gate and a drain that are coupled to one another. The transistor 438 also includes a body diode as shown in FIG. 4. The driver circuitry 442 includes an input terminal coupled to the output terminal of the pre-driver circuitry 401B and an output terminal. The transistor 444 includes a drain coupled to the source of the transistor 438, a gate coupled to the output terminal of the driver circuitry 442, and a source terminal. The transistor 444 also includes a body diode as shown in FIG. 4.

The transistor 448 includes a drain coupled to the COMHN terminal 312. The transistor 448 also includes a gate and a drain that are coupled to one another. The transistor 448 also includes a body diode as shown in FIG. 4. The driver circuitry 452 includes an input terminal coupled to the output terminal of the pre-driver circuitry 401A and an output terminal. The transistor 454 includes a drain coupled to the source of the transistor 448, a gate coupled to the output terminal of the driver circuitry 452, and a source terminal. The transistor 454 also includes a body diode as shown in FIG. 4.

The transistor 458 includes a drain coupled to the source of the transistor 444 and the source of the transistor 454. The transistor 458 also includes a gate and a source coupled to ground. The transistor 460 includes a drain that is coupled to the I_bias terminal 407, a gate coupled to the gate of transistor 458, and a source coupled to ground. The drain and the gate of transistor 460 are also coupled to one another.

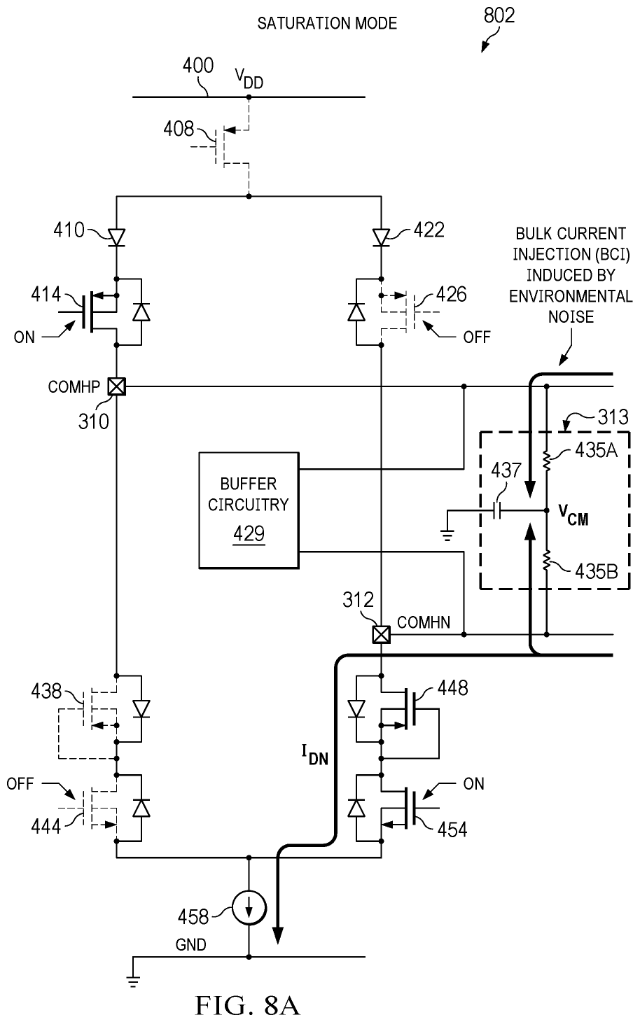

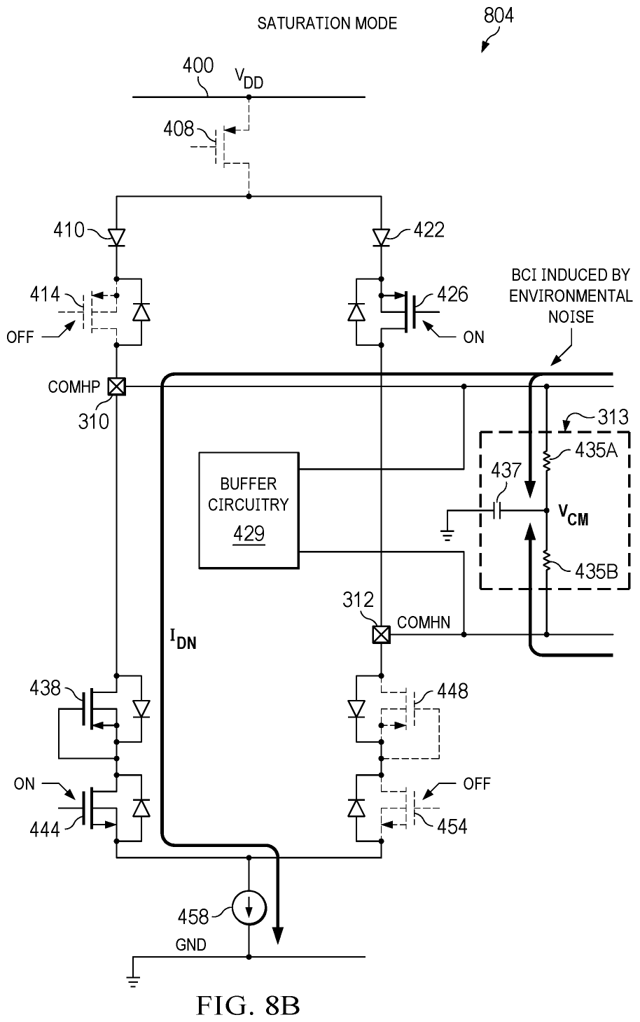

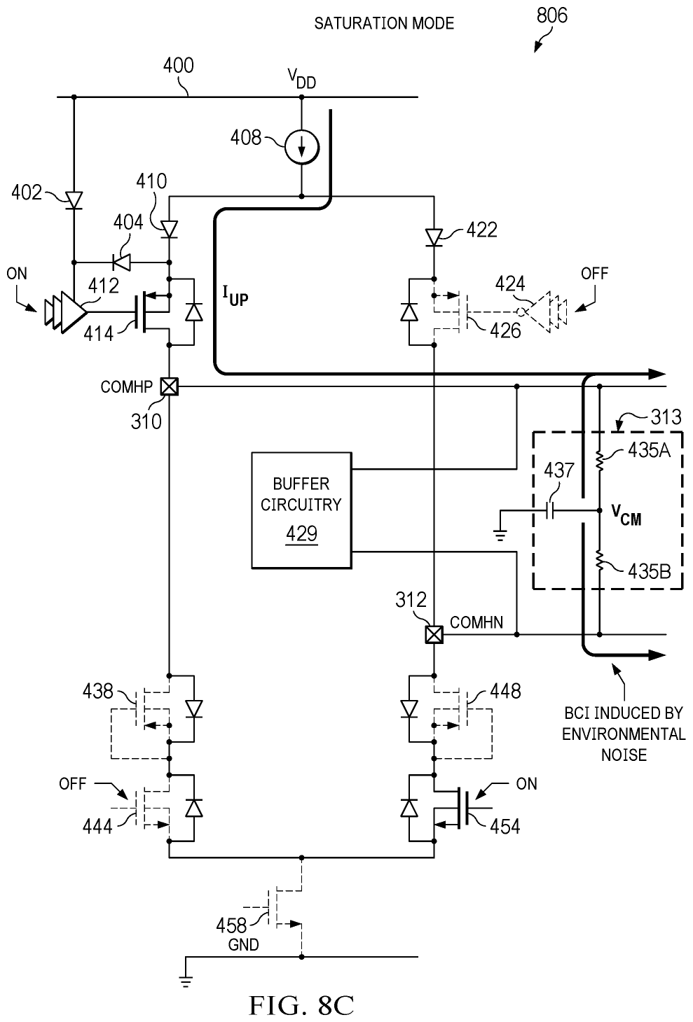

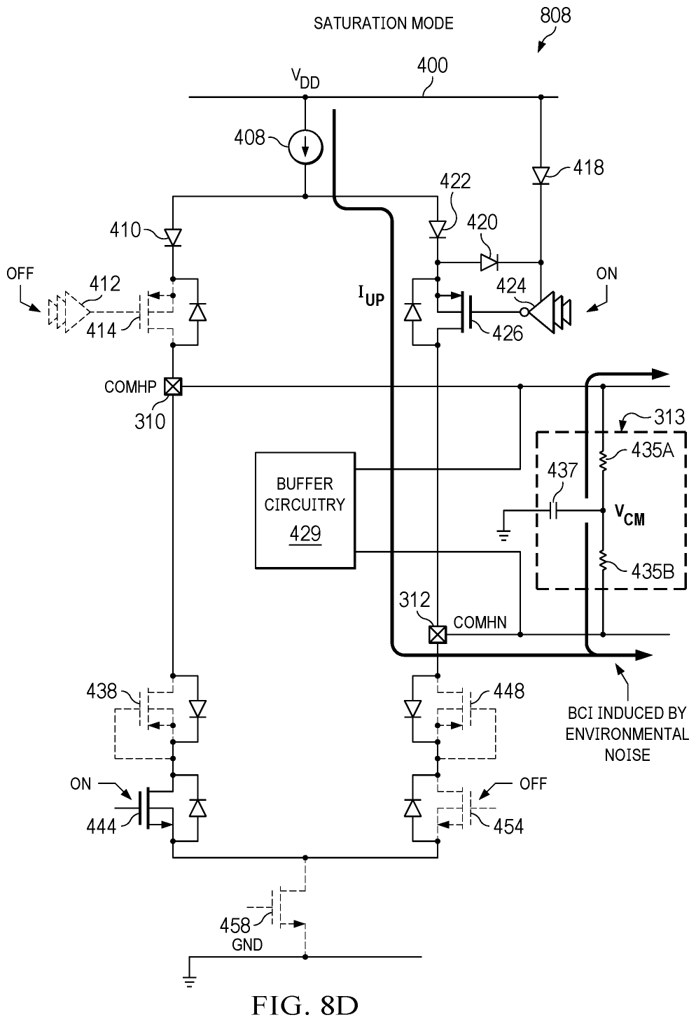

The termination circuitry 313 and capacitors 318 are considered an isolation barrier because they connect to external devices (e.g., the battery module PCBs 206) having different voltages at the respective ground planes. The operation of the termination circuitry 313 is described further in connection with FIGS. 8A-8D and 11.

The ability to connect to the termination circuitry 313 enables the transmitter circuitry 306 to be used in a wider variety of applications than transmitter devices that are not isolated. For example, a transmitter device without an isolation barrier may be inaccurate, suffer hardware damage and/or, more generally, behave unexpectedly in the environment of FIG. 2 because the different voltages within various cells of the batteries 105 cause devices on the daisy chain to operate at different ground plane voltages. In contrast, the transmitter circuitry 306 does provide isolation in the teachings described herein and therefore behaves as expected in the environment of FIG. 2.

FIG. 4 shows how the transmitter circuitry 306 described in the teachings herein forms a full H-bridge architecture. As used above and herein, a full H-bridge architecture generally refers to four switches positioned in an ‘H’ configuration with a load connected in the center of the switches. In FIG. 4, the transistors 414, 426, 444, and 454 are the switches of the full H-bridge, while the buffer circuitry 429, the resistors 435A-435B, and the capacitor 437 can be considered the load.

In addition to including transistors that form a full-H architecture, the transmitter circuitry 306 also includes transistors 406, 408, 460, and 458 to act as current sources when environmental BCI is sufficiently high. Operations in which the transistors 406, 408, 460, and 458 act as current sources are described in connection with FIGS. 8C and 8D.

The transmitter circuitry 306 also includes transistor 438 so that the cathode of the body diode in the transistor 438 is coupled to the cathode of the body diode in the transistor 444. Similarly, the cathode of the body diode of the transistor 448 is coupled to the cathode of the body diode in the transistor 454. The back-to-back body diode configuration prevents any current from flowing through the transistors 444 and 454 when they are turned off, regardless of the direction of the current.

When operating, the full H-bridge architecture enables the transmitter circuitry 306 to transmit using two outgoing communication terminals, COMHP 310 and COMHN 312. The differential reading of the outgoing communication terminals alternates between three different voltage levels, thereby forming an AC coupling and galvanically isolating the transmitter circuitry 306 from external devices. The inclusion of the diode pair 402 and 404, the diode pair 418 and 420, and the buffer circuitry 429 enable the transmitter circuitry 306 to survive high magnitude environmental BCI at various frequencies, and to transmit data without generating large amounts of EMI.

In examples described herein, the transmitter circuitry 306 uses both the COMHP terminal 310 and the COMHN terminal 312 to transmit with an AC coupling because the environment of FIG. 2 causes a need for isolation. In particular, the batteries 105 causing the battery module PCBs 206 to have different ground plane voltages drives a need for isolation. In other examples where isolation is not required, the transmitter circuitry 306 can instead transmit using a DC coupling. To do so, a connected control circuit would use part of the full-H bridge to change the voltage on either the COMHP terminal 310 or the COMHN terminal 312, thereby transmitting a single-ended signal.

The termination circuitry 313 is used to generate differential voltage swings in both linear and saturation modes of the transmitter circuitry 306 as described further below. In the example of FIG. 3 and described herein, the isolation capabilities of the battery module PCB 206A may be referred to as capacitive isolation because the termination circuitry 313 connects to the capacitors 318. In other examples, the battery module PCB 206A implements magnetic isolation by using transformers rather than the capacitors 318. In general, magnetic isolation is less susceptible to capacitive isolation. However, some designers or manufacturers of the battery module PCB 206A choose to implement capacitive isolation rather than magnetic isolation for any number of reasons, including but not limited to cost, space, use case, etc. Notably, the termination circuitry 313 supports both capacitive isolation and magnetic isolation.

In the example of FIG. 4, the transistors 444, 454, 458, and 460 are n-channel metal-oxide semiconductor field-effect transistors (N-MOSFETs). Alternatively, the transistors 444, 454, 458, and 460 may be n-channel field-effect transistors (FETs), n-channel insulated-gate bipolar transistors (IGBTs), n-channel junction field effect transistors (JFETs), NPN bipolar junction transistors (BJTs) and/or, with slight modifications, p-type equivalent devices. In the example of FIG. 4, the transistors 406, 408, 414, 426, 438, 448, 444, and 454 are p-channel MOSFETs. Alternatively, the transistors 406, 408, 414, 426, 438, 448, 444, and 454 may be p-channel FETs, p-channel IGBTs, p-channel JFETs, NPN BJTs, and/or, with slight modifications, N-type equivalent devices. The transistors 406, 408, 414, 426, 438, 448, 444, and 454 may be depletion mode devices, drain-extended devices, enhancement mode devices, natural transistors or other type of device structure transistors. Furthermore, the transistors 406, 408, 414, 426, 438, 448, 444, and 454 may be implemented in/over a silicon substrate (Si), a silicon carbide substrate (SiC), a gallium nitride substrate (GaN) or a gallium arsenide substrate (GaAs).

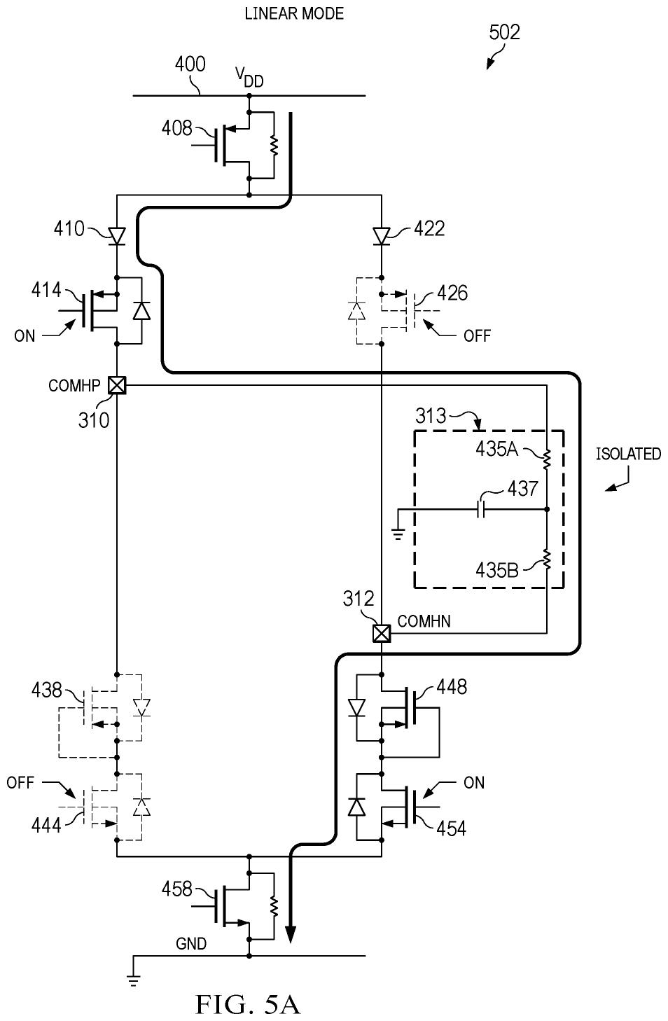

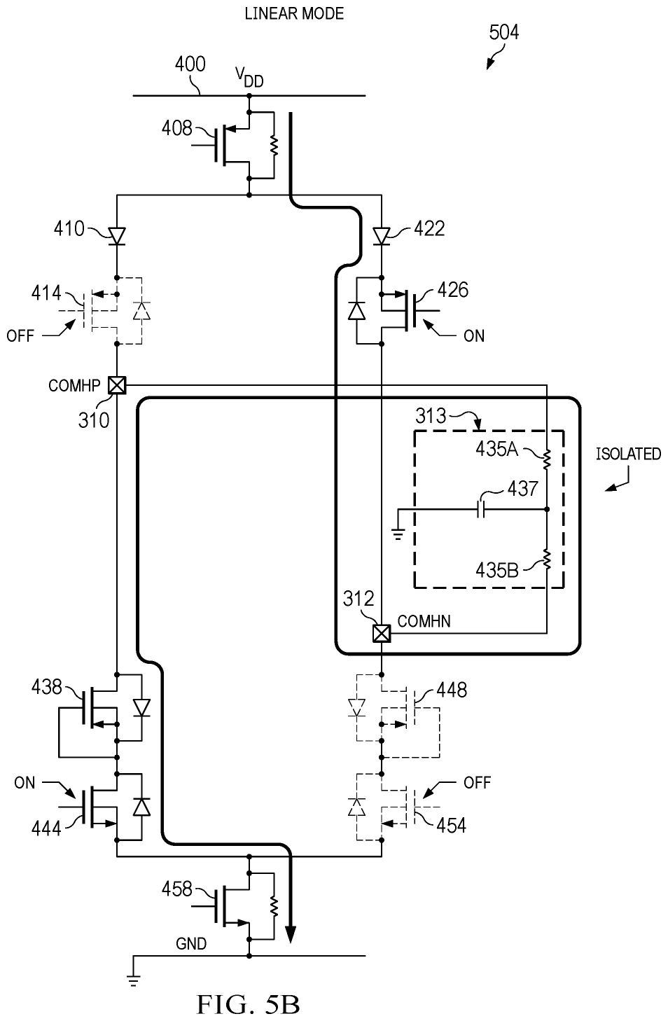

FIGS. 5A and 5B are an illustrative example of the transmitter circuitry of FIG. 3 operating in linear mode. FIG. 5A shows an example configuration 502 and FIG. 5B shows an example configuration 504. Both configurations 502 and 504 are simplified views of the transmitter circuitry 306 that are annotated to show how the transmitter circuitry 306 operates while in linear mode.

The linear mode of the transmitter circuitry 306 refers to operations that occur while the transistors 408 and 458 are in linear mode. Linear mode of a transistor refers to a state in which current through the transistor and voltage across the transistor (e.g., Drain-Source Voltage (VDS)) increase or decrease proportionally to one another (e.g., the transistors 408 and 458 act as resistors as shown in FIGS. 5A and 5B). When the transmitter circuitry 306 is in linear mode, the control circuitry 302 provides input signals that cause the transmitter circuitry 306 to operate in either configuration 502 or configuration 504.

FIG. 5A shows that in configuration 502, the control circuitry 302 provides input signals such that transistors 414 and 454 of the full H-bridge are turned ON while transistors 426 and 444 are turned OFF. Accordingly, in FIG. 5A, current flows from the V_DD terminal 400, through the transistor 408, the diode 410, the transistor 414, and the COMHP terminal 310. Entering the termination circuitry 313, the current then flows through the resistor 435A, and the resistor 435B. Exiting the termination circuitry 313, the current then flows through the COMHN terminal 312, the body diode of transistor 448, the transistor 454, the transistor 458, and to the ground terminal. The flow of current through the resistor 435A and the resistor 435B causes voltage drops such that the voltage at the COMHP terminal 310 is higher than the voltage at the COMHN terminal 312 while in configuration 502. FIG. 5A also shows that the transistors 408 and 458 are biased to functionally act as resistors as described above.

FIG. 5B shows that in configuration 504, the control circuitry 302 provides input signals such that transistors 426 and 444 of the full H-bridge are turned ON while transistors 414 and 454 are turned OFF. Accordingly, in FIG. 5B, current flows from the V_DD terminal 400, through the transistor 408, the diode 422, the transistor 426, the COMHN terminal 312. Entering the termination circuitry 313, the current then flows through the resistor 435B and the resistor 435A. Exiting the termination circuitry 313, the current then flows through the COMHP terminal 310, the body diode of transistor 438 the transistor 444, the transistor 458, and to the ground terminal. The flow of current through the resistor 435B and the resistor 435A causes voltage drops such that the voltage at the COMHN terminal 312 is higher than the voltage at the COMHP terminal 310 while in configuration 504. FIG. 5B also shows the transistors 408 and 458 are biased to functionally act as resistors as described above.

While in linear mode, the control circuitry 302 can transmit digital data (e.g., logical ‘1’s and ‘0’s) by determining the order of configurations 502 and 504 that the transmitter circuitry 306 operates in. For example, devices interpret the voltages on the bi-directional daisy chain of FIG. 2 by subtracting the voltage on the COMHN terminal 312 from the voltage on the COMHP terminal 310 (which may be notated herein as “V_COMHP-V_COMHN” or as “V_DIFF”). Therefore, when the transmitter circuitry 306 operates in configuration 502 first and then configuration 504 next, V_COMHP-V_COMHN transitions from a positive voltage to a negative voltage to represent a digital ‘1’. Similarly, when the transmitter circuitry 306 operates in configuration 504 first and then configuration 502 next, V_COMHP-V_COMHN transitions from a negative voltage to a positive voltage to represent a digital ‘0’.

Notably, the buffer circuitry 429 and diode pairs 402, 404 and 418, 420 are not included in FIGS. 5A and 5B because the transmitter circuitry 306 does not use the buffer circuitry 429 and diode pairs 402, 404 and 418, 420 while in linear mode. By not using the foregoing components while in linear mode, the transmitter circuitry 306 saves power when the BCI from the surrounding environment is sufficiently low.

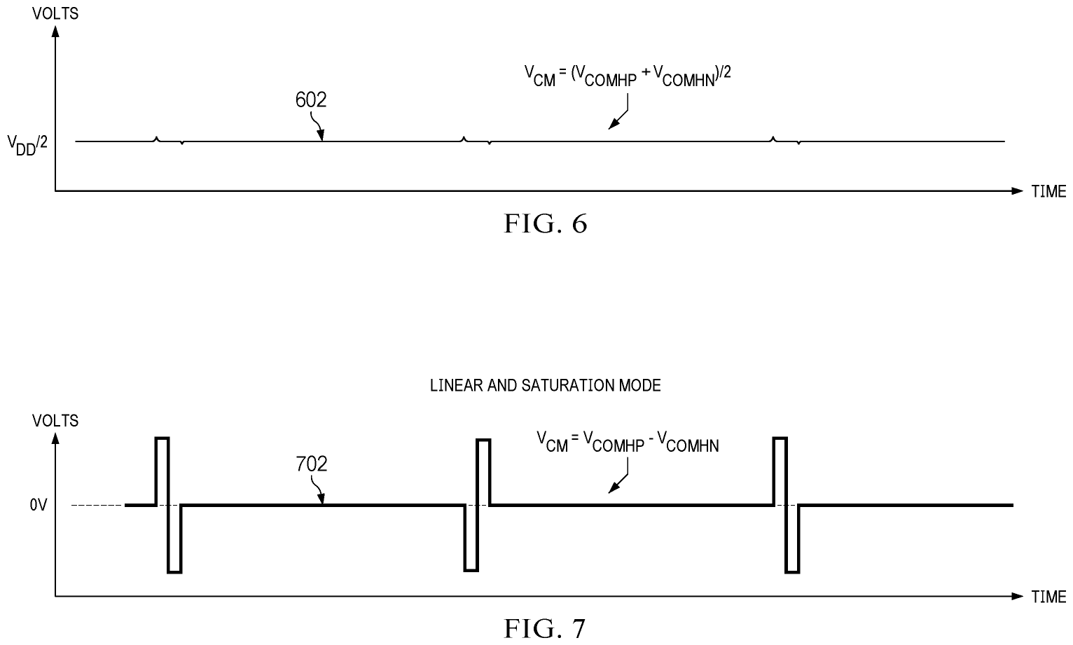

FIG. 6 is a first example graph illustrating the performance of the transmitter circuitry when operating in linear mode. FIG. 6 includes an example Common Mode Voltage (V_CM) signal 602. The V_CM signal 602 represents the average voltage across the COMHP terminal 310 and COMHN terminal 312 over time. Accordingly, V_CM is given by (V_COMHP+V_COMHN)/2. Transmitter devices on the bi-directional daisy chain of FIG. 2 seek to keep the value of V_CM stable over time because changes in V_CM are generally considered a source of EMI that causes noise for other devices. In examples described herein, transmitter devices seek to keep V_CM equal to half the voltage at the V_DD terminal 400 (annotated herein as V_DD/2). In other examples, transmitter devices seek to keep V_CM at a different value.

FIG. 6 shows that, while the transmitter circuitry 306 is in linear mode, the V_CM signal 602 stays relatively stable at V_DD/2. For example, any variations to the value of V_CM signal 602 due to the transmission of a logical ‘1’ or ‘0’ are small in magnitude and do not impact the average voltage over time (e.g., any increase in V_CM has a corresponding decrease and vice versa). Accordingly, the transmitter circuitry 306 exhibits little to no EMI generation while in linear mode.

FIG. 7 is an example graph illustrating the output of the transmitter circuitry when operating in linear and saturation mode. FIG. 7 includes an example V_DIFF signal 702 that represents how devices interpret the voltages on the COMHP terminal 310 and COMHN terminal 312 (e.g., the value of V_COMHP-V_COMHN). As described above in connection with FIG. 7, devices interpret V_DIFF transitioning from a positive value to a negative value as a logical ‘1’ and V_DIFF transitioning from a negative value to a positive value as a logical ‘1’. Accordingly, FIG. 7 shows a digital sequence ‘101’.

Devices connected to the bi-directional daisy chain of FIG. 2 transmit signals using Manchester Encoding. Manchester Encoding is a data encoding protocol where a given bit is represented at two voltage states (e.g., a low voltage and then a high voltage, or a high voltage and then a low voltage) for equal time. The equal time of the two voltage states allow Manchester encoding to be self-clocking (e.g., signals formatted with Manchester Encoding can be interpreted without a separate clock signal). As a result, electrical connections that use Manchester Encoding, including but not limited to the COMHP terminal 310 and COMHN terminal 312, can be easily galvanically isolated.

The transmitter circuitry 306 generally operates in linear mode when the amount of environmental BCI is below a threshold and in saturation mode when the amount of BCI is above a threshold. Notably, signals transmitted by the transmitter circuitry 306 during both the linear and saturation modes are formatted with Manchester encoding. Accordingly, the battery module PCB 206A can remain galvanically isolated from other devices regardless of the presence of environmental BCI. Saturation mode is described further in connection with FIGS. 8A-8D.

FIGS. 8A-8D are an illustrative example of the transmitter circuitry of FIG. 3 operating in saturation mode. FIGS. 8A, 8B, 8C, and 8D show configurations 802, 804, 806, 808, respectively. The configurations 802, 804, 806, and 808 are simplified views of the transmitter circuitry 306 that are annotated to show how the transmitter circuitry 306 operates while in saturation mode.

When environmental noise causes a sufficiently high amount of BCI, the current flowing throughout the transmitter circuitry 306 changes values. In some instances, excess current is introduced into the transmitter circuitry 306 via the COMHP terminal 310 and the COMHN terminal 312. In other instances, excess current flows out of the transmitter circuitry 306 via the COMHP terminal 310 and the COMHN terminal 312. During such changes to the value of the excess current, internal headroom within the transistors 408 and 458 causes one or more of the transistors 408 and 458 to operate in saturation mode. As described herein, saturation mode of the transmitter circuitry 306 refers to when the transistors 408 or 458 are in saturation mode.

FIG. 8A shows configuration 802, which is used by the transmitter circuitry 306 when excess current flows into the transmitter circuitry 306. In configuration 802, the control circuitry 302 provides input signals such that transistors 414 and 454 of the full H-bridge are ON while transistors 426 are 444 are OFF. However, in configuration 802, the excess current causes a negative voltage at the COMHP terminal 310 such that the transistor 414 lacks headroom and functionally acts OFF. Accordingly, no path exists for the excess current to flow to the V_DD terminal 400. Instead, the excess current in configuration 802 enters at the COMHP terminal 310 and the COMHN terminal 312, through the body diode of transistor 448, the transistor 454, the saturated transistor 458, and to the ground terminal. Accordingly, the transistor 458 can be represented as a current source that provides a constant downward current (I_DN) as shown in FIG. 8A. Furthermore, in configuration 802, an amount of excess current flows from the COMHP terminal 310, through the resistors 435A and 435B, the capacitor 437, through the COMHN terminal 312, and eventually to the ground terminal. The foregoing current flow from the COMHP terminal 310 to the COMHN terminal 312 causes a voltage drop such that V_COMHP-V_COMHN is a positive value.

FIG. 8B shows configuration 804, which is also used by the transmitter circuitry 306 when excess current flows into the transmitter circuitry 306. In configuration 804, the control circuitry 302 provides input signals such that transistors 426 and 444 of the full H-bridge are ON while transistors 414 and 454 are OFF. However, in configuration 804, the excess current causes a negative voltage at the COMHN terminal 312 such that the transistor 426 lacks headroom and functionally acts OFF. Headroom generally refers to the voltage swing available to apply across the current terminals. Transistors require a minimum voltage drop across the current terminals to close the transistor and have the component functionally act ON. Therefore, if a circuit causes the available voltage swing at a transistor to be less than the required voltage swing to operate the transistor, the transistor is considered to lack headroom and functionally acts OFF.

Because the transistor 426 lacks headroom and functionally acts OFF, no path exists for the excess current to flow to the V_DD terminal 400. Instead, the excess current in configuration 804 enters at the COMHP terminal 310 and the COMHN terminal 312, through the body diode of the transistor 438, the transistor 444, the saturated transistor 458, and to the ground terminal. Accordingly, the transistor 458 can be represented as a current source that provides I_DN as shown in FIG. 8B. Furthermore, in configuration 804, an amount of excess current flows from the COMHN terminal 312, through the resistor 435B, the capacitor 437, the resistor 435A, through the COMHP terminal 310, and to the ground terminal. The foregoing current flow from the COMHN terminal 312 to the COMHP terminal 310 causes a voltage drop such that V_COMHP-V_COMHN is a negative value.

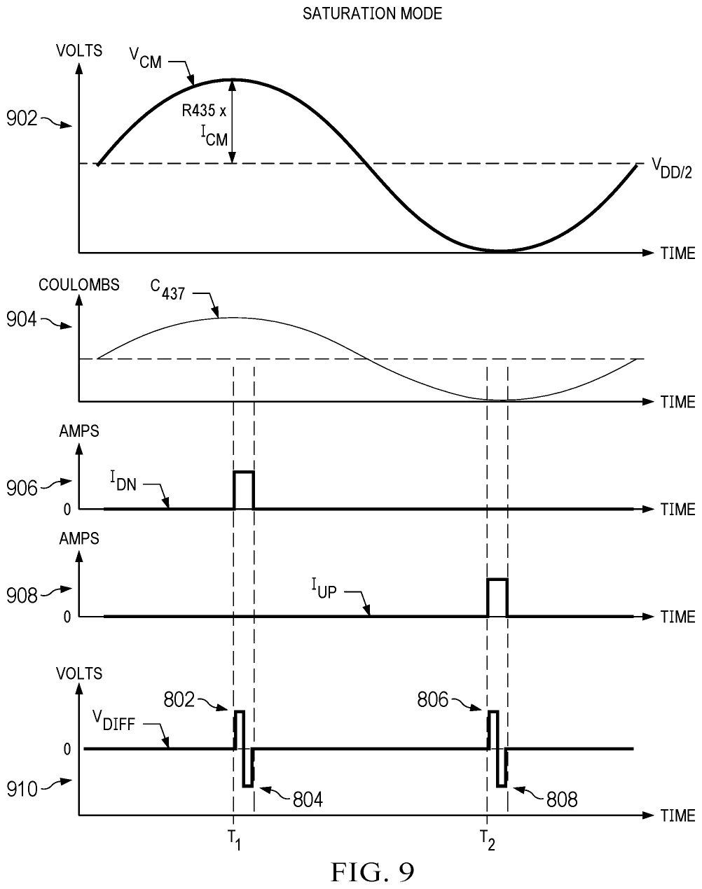

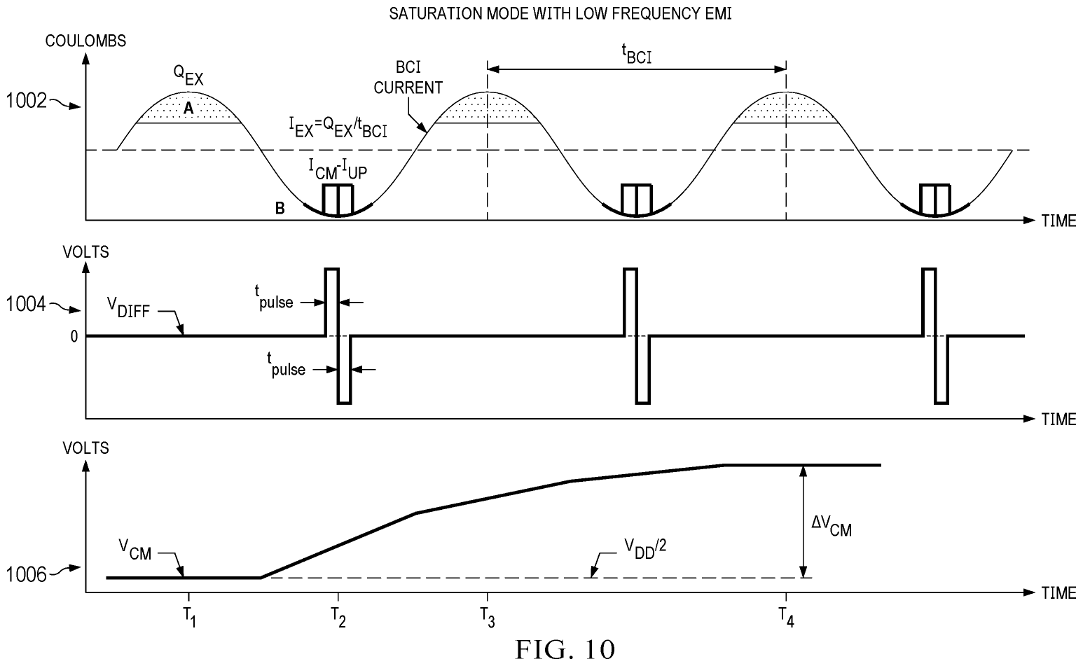

One technique the control circuitry 302 can use to transmit digital data while in saturation mode is to determine the order of configurations 802 and 804 that the transmitter circuitry 306 operates in. For example, when the transmitter circuitry 306 operates in configuration 802 first and then configuration 804 next, V_COMHP-V_COMHN transitions from a positive voltage to a negative voltage to represent a digital ‘1’ using Manchester Encoding. Similarly, when the transmitter circuitry 306 operates in configuration 804 first and then configuration 802 next, V_COMHP-V_COMHN transitions from a negative voltage to a positive voltage to represent a digital ‘0’ using Manchester Encoding. The timing of operations performed in configurations 802 and 804 are described further in connection with FIG. 9.

FIG. 8C shows configuration 806, which is used by the transmitter circuitry 306 when current flows out of the transmitter circuitry 306. In configuration 806, the control circuitry 302 provides input signals such that transistors 414 and 454 of the full H-bridge are ON while transistors 426 and 444 are OFF. However, in configuration 804, the outgoing current causes a positive voltage at the COMHN terminal 312 such that the transistor 454 lacks headroom and functionally acts OFF. Accordingly, no path exists for the excess current to flow to the ground terminal. Instead, the outgoing current in configuration 806 flows from the V_DD terminal 400, through the saturated transistor 408, the diode 410, the transistor 414, and out the COMHP terminal 310. Accordingly, the transistor 408 can be represented as a current source that provides a constant upward current (I_UP) as shown in FIG. 8C. An amount of the outgoing current also flows through resistor 435A, the capacitor 437, the resistor 435B, and out the COMHN terminal 312. The foregoing current flow from the COMHP terminal 310 to the COMHN terminal 312 causes a voltage drop such that V_COMHP-V_COMHN is a positive value.

FIG. 8D shows configuration 808, which is also used by the transmitter circuitry 306 when current flows out of the transmitter circuitry 306. In configuration 808, the control circuitry 302 provides input signals such that transistors 426 and 444 of the full H-bridge are ON while transistors 414 and 454 are OFF. However, in configuration 804, the outgoing current causes a positive voltage at the COMHN terminal 312 such that the transistor 454 lacks headroom and functionally acts OFF. Accordingly, no path exists for the excess current to flow to the ground terminal. Instead, the BCI current in configuration 802 flows from the V_DD terminal 400, through the saturated transistor 408, the diode 422, the transistor 426, and out the COMHN terminal 312. Accordingly, the transistor 408 can be represented as a current source that provides I_UP as shown in FIG. 8D. An amount of the BCI current also flows through resistor 435B, the capacitor 437, the resistor 435A, and out the COMHP terminal 310. The foregoing current flow from the COMHN terminal 312 to the COMHP terminal 310 causes a voltage drop such that V_COMHP-V_COMHN is a negative value.

Another technique the control circuitry 302 can use to transmit digital data while in saturation mode is to determine the order of configurations 806 and 808 in which the transmitter circuitry 306 operates. For example, when the transmitter circuitry 306 operates in configuration 806 first and then configuration 808 next, V_COMHP-V_COMHN transitions from a positive voltage to a negative voltage to represent a digital ‘1’ using Manchester Encoding. Similarly, when the transmitter circuitry 306 operates in configuration 808 first and then configuration 806 next, V_COMHP-V_COMHN transitions from a negative voltage to a positive voltage to represent a digital ‘0’ using Manchester Encoding. The timing of operations performed in configurations 806 and 808 are described further in connection with FIG. 9.

Notably, each of FIGS. 8A-8D include the buffer circuitry 429 because the buffer is powered and in use when the transmitter circuitry is in saturation mode. Similarly, the diode pair 402 and 404 are shown in FIG. 8C because current flows through said components during configuration 806. Likewise, the diode pair 418 and 420 are shown in FIG. 8D because current flows through said components during configuration 808. The buffer circuitry 429 is described further in connection with FIG. 11, while diode pairs 402, 404, and 418, 420 are described further in connection with FIGS. 12 and 13.

FIG. 9 is an example graph illustrating the performance of the transmitter circuitry 306 when operating in saturation mode. FIG. 9 shows example graphs 902, 904, 906, 908, and 910. The graphs of FIG. 9 illustrate various properties of the transmitter circuitry 306 during saturation mode. For example, graph 902 shows how the value of V_CM changes over time, graph 904 shows how the charge in the capacitor 437 changes over time, graph 906 shows how the value of I_DN changes over time, graph 908 shows how the value of I_UP changes over time, and graph 910 shows how the value of V_DIFF changes over time. The graphs of FIG. 9 are vertically aligned so that their x axes are equal (e.g., T1 refers to the same point in time on graphs 902, . . . , 910, and T2 refers to the same point in time on graphs 902, . . . , 910).

When the magnitude of environmental BCI is sufficiently high, graphs 902 and 904 show that the noise induces a periodic component (e.g., an AC component) in the V_CM signal of the transmitter circuitry. The periodic component of the V_CM also causes a periodic component to the level of charge on the capacitor 437. In the example of FIG. 9, the values of V_CM and the charge on capacitor 437 both reach a local maximum at T1. The magnitude of V_CM at T1 is given by equation (1):

$$V\_CM = R 435 \times I\_CM \qquad ( Eq . 1 )$$

As used above and herein, R435 refers to the value of either resistor 435A or resistor 435B (noting that the two components have equal resistance) and I_CM is a static value.

If the control circuitry 302 has digital data to share with other devices at T1, the excess current causes the transmitter circuitry 306 to operate in either configuration 802 or 804. Accordingly, the graph 906 shows I_DN at a constant current, and graph 908 I_UP at 0 Amps, while graph 910 shows the control circuitry 302 sends a logical ‘1’ at T1 (e.g., the transmitter circuitry 306 operates first in configuration 802, and then in configuration 804). After the transmitter circuitry 306 completes transmission of the logical ‘1’ that began at T1, the control circuitry 302 sends input signals to turn all the transistors 414, 426, 444, 454 in the full H-bridge OFF. Accordingly, I_DN falls back to 0 Amps (A) at such time because there is no longer a closed electrical path from the COMHP 310, COMHN 312 terminals to ground, so the transistor 458 no longer acts as a current source. However, because the magnitude of received BCI is subject to environmental conditions and not subject to the decision of the control circuitry 302 to transmit data, the graphs 902 and 904 show that V_CM and the charge on the capacitor 437 continue to oscillate after I_DN falls back to 0 A.

At T2, the graph 904 shows the charge on the capacitor 437 reaches a local minimum. Similarly, the graph 902 shows the value of V_CM also reaches a local minimum. The difference in magnitude of V_CM at T2 is given by equation (2):

$$V\_CM = - R 435 \times I\_CM \qquad ( Eq . 2 )$$

If the control circuitry 302 has digital data to share with other devices at T2, the excess current causes the transmitter circuitry 306 to operate in either configuration 806 or 808. Accordingly, the graph 906 shows I_DN at 0 Amps and graph 908 I_UP at a constant current, while graph 910 shows the control circuitry 302 sends a logical ‘1’ at T2 (e.g., the transmitter circuitry 306 operates first in configuration 806, and then in configuration 808). After the transmitter circuitry 306 completes transmission of the logical ‘1’ that began at T2, the control circuitry 302 sends input signals to turn all the transistors 414, 426, 444, 454 in the full H-bridge OFF. Accordingly, I_UP falls back to 0 Amps (A) at such time because there is no longer a closed electrical path from the V_DD terminal 400 to COMHP 310, COMHN 312 terminals, so the transistor 408 no longer acts as a current source. However, because the amount of received BCI is subject to environmental conditions and not subject to the decision of the control circuitry 302 to transmit data, the graphs 902 and 904 show that V_CM and the charge on the capacitor 437 continue to oscillate after I_UP falls back to 0 A.

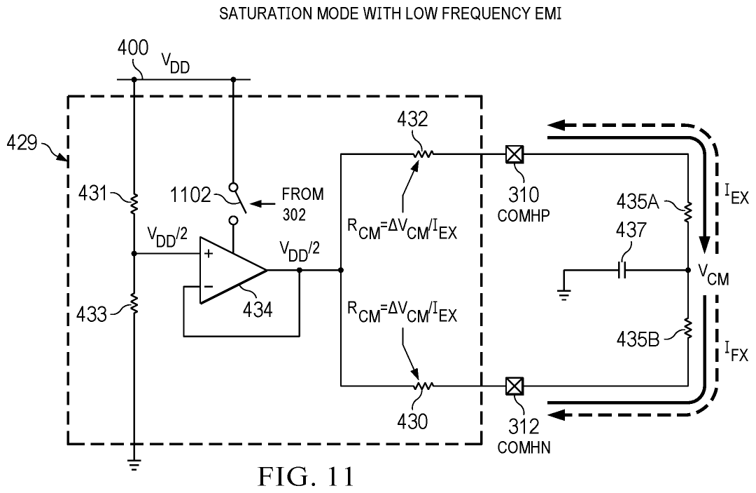

FIG. 10 is an example graph illustrating the transmitter circuitry when operating in saturation mode and exposed to low frequency bulk current injection. FIG. 10 includes graphs 1002, 1004, and 1006. The graph 1002 is an example implementation of how the current caused by BCI changes over time in saturation mode, the graph 1004 is an example implementation of how V_DIFF changes over time, and the graph 1006 is an example implementation of how V_CM changes over time. The graphs of FIG. 10 are vertically aligned so that their x axes are equal (e.g., the timestamps T1, T2, T3, and T4 ______ refer to the same points in time on graphs 1002, 1004, and 1006). The timestamps of FIG. 10 are independent of and separate from the timestamps of FIG. 9.

Environmental noise seen on the COMHP 310 and COMHN 312 terminals can vary in both magnitude and frequency. For example, the DC component of V_CM shown on graph 902 remaining at (V_DD/2) occurs in examples where the BCI current changes value at a sufficiently high frequency that the total charge on the capacitor 437 remains within an expected range of values. However, in other examples, environmental BCI cause the charge on the capacitor 437 to oscillate at a slower frequency that matches the frequency of data transmission. In FIG. 10, the graphs 1002 and 1004 show that the two pulses that collectively form a digital bit in V_DIFF occur during and near the local minimums of I_CM (e.g., during and around T2).

The capacitors that form the level-shifted differential interface of FIG. 2 are sufficiently sized to withstand the BCI current that periodically flows into and out of the transmitter circuitry 306. When data transmission is aligned with BCI current flowing out of the transmitter device, the data transmission causes an excess charge that capacitors of FIG. 2 cannot store. Instead, the excess charge is stored in the capacitor 437. The amount of this excess charge is given by equation (3):

$$Q\_EX = I\_UP \times 2 ( t\_pulse ) \qquad ( Eq . 3 )$$

As used above and herein, Q_EX refers to excess charge on the capacitor 437, and t_pulse refers to the amount of time the transmitter circuitry 306 spends in any one of configurations 802, 804, 806, 808 to perform half of the operations required to transmit a bit with Manchester Encoding. The excess charge of equation (3) can be represented as an excess current that continually charges the capacitor 437. The magnitude of the excess current is given by equation (4):

$$I\_EX = Q\_EX / t\_BCI \qquad ( Eq . 4 )$$

As used above and herein, I_EX refers to excess current that charges capacitor 437, and t_BCI refers to the period of the oscillating BCI current signal (e.g., T4-T3 in FIG. 10). Because the timing of the data transmission continually produces Q_EX and I_EX, to flow between the COMHP terminal 310 and the COMHN terminal 312, the value of V_CM (e.g., the average value of the voltages at the COMHP 310 and COMHN terminals 312) increases. Similarly, graph 1006 shows that the value of V_CM increases whenever data transmission aligns with a local minimum in the oscillating BCI current signal of graph 1002.

While FIG. 10 shows data transmission synchronized with local minimums in the BCI current, in other examples, data transmission may instead be synchronized with local maximums in the BCI signal (e.g., the pulses in V_DIFF may be shifted in time so that the first bit is centered at T1 rather than T2). In such other examples, the transistors 414 and 426 lack headroom to operate and the V_DD terminal 400 is functionally disconnected from external devices as shown in FIGS. 8A and 8B. To replace the role of the V_DD terminal 400, capacitor 437 produces a current that connects to the external devices and supports data transmission. The current produced for data transmission causes the charge on the capacitor 437 to decrease below a nominal value, thereby causing a decrease in the value of the V_CM.

If data transmission continued to be synchronized with either local minima or local maxima of the oscillating BCI current signal of graph 1002, the value of V_CM may continue to increase or decrease away from the value of V_DD/2 as shown in the graph 1006. Such a shift in the value of V_CM would generate EMI as described above, thereby decreasing the performance of both the battery module PCB 206A and all devices connected to the daisy chain of FIG. 2. However, the transmitter circuitry 306 includes buffer circuitry 429 described in the teachings herein to counteract such shifts in V_CM.

FIG. 11 is an example implementation of the common mode buffer circuitry of the transmitter circuitry of FIG. 3. FIG. 11 shows the buffer circuitry 429, which includes the resistors 430, 431, 432, 433, and the amplifier circuitry 434. FIG. 11 also shows the termination circuitry 313, which includes the resistors 435A, 435B, and the capacitor 437.

The amplifier circuitry 434 includes a first input terminal that is connected in between the resistors 431 and 433. Through their connections to one another, the V_DD terminal 400, and the ground terminal, the resistors 431 and 433 collectively form a voltage divider. In examples described herein, the resistors 431 and 433 have equal value such that the amplifier circuitry 434 receives V_DD/2 (e.g., the nominal common mode voltage) at the first input terminal. The amplifier circuitry 434 also includes a second input terminal that is coupled to the output terminal of the amplifier circuitry 434.

In the example of FIG. 11, the amplifier circuitry 434 includes a supply terminal that is coupled to the first terminal of the switch 1102. The second terminal of the switch 1102 is coupled to the V_DD terminal 400. As a result, the buffer circuitry 429 receives power (e.g., is turned ON) and can perform operations while the switch 1102 is closed. Similarly, the buffer circuitry 429 is turned OFF when the switch 1102 is open.

The control circuitry 302 sends a control signal to the transmitter circuitry 306 that changes the state of switch 1102, thereby turning the buffer circuitry 429 ON or OFF. The control circuitry 302 determines whether to power the buffer circuitry 429 based on feedback from the receiver circuitry 308 that describes the amount of BCI experienced by the COMHP terminal 310 and COMHN terminal 312. When the amount of environmental BCI exceeds a threshold, the control circuitry 302 causes the switch 1102 to close, thereby powering the buffer circuitry 429 and counteracting the shift in V_CM described below. Alternatively, when the amount of environmental BCI is below the threshold, the control circuitry 302 causes the switch 1102 to open, thereby saving power by turning the buffer circuitry 429 OFF when it is not needed. In other examples, the buffer circuitry 429 does not include a switch 1102. In such other examples, the buffer circuitry 429 is instead continually powered via a direct connection between the supply terminal of the amplifier circuitry 434 and the V_DD terminal 400.

When environmental BCI is at a low enough frequency that it synchronizes with data transmission, the amount of charge on the capacitor 437 may exit its expected range, thereby causing a shift in V_CM as described above in connection with FIG. 10. Such a shift is embodied as an imbalance at the either an increase or decrease in the voltage at the COMHP terminal 310 and the COMHN terminal 312.

When environmental BCI is not synchronized with data transmission, the voltage at either terminal of the resistor 430 is balanced at V_CM=(V_DD/2). Similarly, the voltage at either terminal of the resistor 432 is balanced at the same voltage when environmental BCI is not synchronized. As a result, the foregoing shift in V_CM shift causes a voltage imbalance at the resistors 430 and 432.

The voltage imbalance at the resistors 430 and 432 causes an amount of current to flow through the resistors 430 and 432. The amount of the current emitted is given by the resistance value of the resistors 430 and 432. In the example of FIG. 11, the resistors 430 and 432 have the same common mode resistance (R_CM) value given by equation (5):

$$R\_CM = Δ V\_CM / I\_EX \qquad ( Eq . 5 )$$

As used above and herein, ΔV_CM refers to the difference between the value of V_CM and V_DD/2 as shown in FIG. 10. That is, R_CM may be a static, pre-determined value that is chosen based on a maximum allowable shift in the measured common mode voltage. Such a maximum allowable shift in V_CM may be described in a system-level performance requirement. For example, to meet vehicle safety standards, devices connected to the daisy chain of FIG. 2 may be disallowed from emitting a certain amount of EMI, and therefore disallowed from the magnitude of ΔV_CM exceeding a certain value.

The flow of current through the resistors 430 and 432 causes the capacitor 437 to either charge or discharge in a manner that counteracts the foregoing shift in V_CM. For example, if synchronous data transmission causes an increase in V_CM as shown in FIG. 10, then the voltage at the COMHP terminal 310 and COMHN terminal 312 decreases. The change causes a voltage imbalance at the resistors 430 and 432 such that the excess charge previously stored in the capacitor 437 exits the capacitor 437 and flows as a current through the resistors 430 and 432. Alternatively, if the synchronous data transmission causes a decrease in V_CM, then the voltage at the COMHP terminal 310 and COMHN terminal 312 increases. The change causes a voltage imbalance at the resistors 430 and 432 such that the current from the amplifier circuitry flows through the resistors 430 and 432 and recharges the capacitor 437. As such, transmitter devices implemented according to the teachings described herein do not shift the average value of V_CM over time, even when environmental BCI is present at a frequency that happens to match data transmission.

FIG. 12 is an example graph of the output of the transmitter circuitry 306 without a diode pair when operating in saturation mode and exposed to high frequency bulk current injection. FIG. 12 includes example graphs 1202, 1204, and 1206. The graphs of FIG. 12 include y axes that represent voltage and x axes that represent time in microseconds (μs). The graphs of FIG. 12 are vertically aligned so that the x axes are equivalent (e.g., the timestamp 25.425 μs refers to the same point in time on each graph).

the graph 1202 shows an example implementation of how V_CM changes over time and the graph 1204 shows an example implementation of how V_SRC changes over time. As shown in FIGS. 8C and 8D, V_SRC refers to the voltage used to power the driver circuitry 412 and 424. In particular, FIG. 4 shows that the pre-driver circuitry 401C receives V_SRC by coupling to the diode pair 402 and 404. The pre-driver circuitry 401C then uses V_SRC to generate an output that powers the driver circuitry 412. Similarly, the pre-driver circuitry 401D receives V_SRC by coupling to the diode pair 418 and 420. The pre-driver circuitry 401D then uses V_SRC to generate an output that powers the drive circuitry 424.

Environmental BCI that is at a relatively high frequency may introduce errors in other areas of circuit operation besides synchronization with data transmission. For instance, the graph 1204 shows that V_CM oscillates at a frequency of approximately 16 Mega Hertz (MHz). Normally, the value of V_SRC oscillates at the same frequency as the V_CM signal while maintaining a nominal DC component (e.g., +5.0 V). In FIG. 12, however, the high frequency of the BCI causes the one or both of the V_SRC terminals powering the driver circuitry 412 and 424 to deviate significantly below the nominal DC value (e.g., V_SRC<1 V at approximately 25.559 μs). The change in voltage at the V_SRC terminals occurs because the diodes 410 and 422 are coupled to one another as shown in FIG. 4. The change in voltage may cause the corresponding driver circuitry 412 and 424 to become unable to respond to a signal from the control circuitry 302 to turn OFF, instead remaining ON for longer than anticipated. Such an error may degrade the ability for the control circuitry 302 to control the output of the transmitter circuitry 306, thereby misshaping the V_DIFF signal and degrading the performance of the transmitter circuitry 306. For example, FIG. 12 shows that because of high frequency BCI noise, the falling edge of a pulse in V_DIFF occurs approximately 10 nanoseconds later than the control circuitry 302 intended it to.

Notably, the graphs 1204 and 1206 are misshapen because they represent the performance of a transmitter device that does not include a diode pair to counteract the presence of high frequency BCI. In contrast, the transmitter circuitry 306 does include diode pairs 402, 404, and 418, 420 as described in the teachings herein. The presence of the diode pairs improves the performance of the transmitter circuitry 306 as shown in FIG. 13.

FIG. 13 is an example graph of the transmitter circuitry 306 of FIG. 3. FIG. 13 includes the graph 1202 of FIG. 12, indicating the devices of FIG. 12 and FIG. 13 are subject to the same high frequency BCI environmental conditions. FIG. 13 also includes graphs 1304, and 1306, which are examples of how the values of V_SRC and V_DIFF in the transmitter circuitry 306 change over time, respectively.

In the transmitter circuitry 306, the cathodes of diodes 402, 404 are connected to one another and to the pre-driver circuitry 401C. Such a configuration keeps the V_SRC terminal that powers driver circuitry 412 above a threshold voltage (e.g., the diode pairs enforce a minimum voltage of approximately +2.0 V in graph 1304), even when high frequency BCI occurs. Similarly, the cathodes of diodes 418, 420 are connected to one another such that the V_SRC terminal that powers driver circuitry 424 stays above a threshold voltage during high frequency BCI.

The threshold voltage maintained by the diode pairs 402, 404 and 418, 420 is sufficiently high such that the driver circuitry 412 and 424 can respond to the control circuitry 302 and turn OFF when instructed to do so. Accordingly, the actual values of V_DIFF in graph 1306 matches the intended value better than graph 1206. Variations between the signal intended by control circuitry 302 and the actual V_DIFF signal still occur in graph 1306 due to propagation delays and a difference between the digital logic voltages and analog transmission voltages. In general, however, the use of diode pairs in the transmitter circuitry 306 improves performance and makes the transmitter circuitry 306 survivable in environments where high frequency BCI may occur.

FIG. 14 is a flowchart representative of example machine-readable instructions and example operations 1400 that may be executed, instantiated, and/or performed by programmable circuitry to transmit a signal. The example machine-readable instructions and the example operations 1400 of FIG. 14 may be performed by the control circuitry 302 and the transmitter circuitry 306 of FIG. 3.

The machine-readable instructions and operations 1400 begin when the control circuitry 302 generates digital data for transmission. (Block 1402). As used above and herein, digital data refers to any sequence of logical bits. The control circuitry 302 may generate digital data for any reason, including but not limiting to reporting characteristics of connected cells within the batteries 105. The digital data generated by the control circuitry 302 may be intended for any device within FIG. 2 (e.g., the MCU 202).

If the magnitude of the environmental BCI is below a threshold value (Block 1404: No), the full H-bridge of the transmitter circuitry 306 operates in linear mode to transmit the digital data. (Block 1406). The transmitter circuitry 306 implements linear mode when the transistors 408 and 458 functionally act as resistors as shown in FIGS. 5A and 5B.

In general, to send a logical ‘1’ bit using Manchester Encoding, the control circuitry 302 first turns transistors 414 and 454 ON while keeping transistors 426 and 444 turned OFF. The control circuitry 302 then turns transistors 426 and 444 ON while turning transistors 414 and 454 turned OFF. To send a logical ‘0’ using Manchester Encoding, the control circuitry 302 first turns transistors 426 and 444 ON while keeping transistors 414 and 454 turned OFF. The control circuitry 302 then turns transistors 414 and 454 ON while turning transistors 426 and 444 turned OFF.

Therefore, to generate a logical ‘1’ bit during block 1406, the control circuitry 302 sends input signals such that the transmitter circuitry 306 operates first in configuration 502 and then in configuration 504. Similarly, to send a logical ‘0’ bit, the control circuitry 302 provides input signals such that the transmitter circuitry 306 operates first in configuration 504 and then in configuration 502. The machine-readable instructions and operations 1400 end after block 1406.

If the magnitude of environmental BCI is above a threshold (Block 1404: Yes), an amount of BCI current influences the transmitter circuitry 306. As referred to above and in the context of block 1408, a positive value of BCI current means that current is being injected into the COMHP terminal 310 and COMHN terminal 312 (as shown in FIGS. 8A and 8B), while a negative value of BCI current means that current is flowing out of the COMHP terminal 310 and COMHN terminal 312 (as shown in FIGS. 8A and 8B).

If the value of the BCI current is positive (Block 1408: Yes), the transmitter circuitry 306 uses the full H-bridge in a first set of saturated mode configurations to transmit the digital data. (Block 1410). The transmitter circuitry 306 implements the first set of configurations in saturation mode of the transmitter circuitry 306 when the transistor 458 operates as a current source and the transistor 408 is functionally turned OFF due to a lack of headroom, as described above in connection with FIGS. 8A and 8B. Therefore, to send a logical ‘1’ bit, the control circuitry 302 provides input signals such that the transmitter circuitry 306 operates first in configuration 802 and then in configuration 804. Similarly, to send a logical ‘0’ bit, the control circuitry 302 provides input signals such that the transmitter circuitry 306 operates first in configuration 804 and then in configuration 802. In doing so, the control circuitry 302 causes the transmitter circuitry 306 to encode the digital data using Manchester Encoding. The machine-readable instructions and operations 1400 proceed to block 1414 after block 1410.

If the value of the BCI current is negative (Block 1408: No), the transmitter circuitry 306 uses the full H-bridge in a second set of saturated mode configurations to transmit the digital data. (Block 1410). The transmitter circuitry 306 implements the second set of configurations in saturation mode of the transmitter circuitry 306 when the transistor 408 operates as a current source and the transistor 458 is functionally turned OFF due to a lack of headroom, as described above in connection with FIGS. 8C and 8D. Therefore, to send a logical ‘1’ bit, the control circuitry 302 provides input signals such that the transmitter circuitry 306 operates first in configuration 806 and then in configuration 808. Similarly, to send a logical ‘O’ bit, the control circuitry 302 provides input signals such that the transmitter circuitry 306 operates first in configuration 808 and then in configuration 806. In doing so, the control circuitry 302 causes the transmitter circuitry 306 to encode the digital data using Manchester Encoding.

In the example of FIGS. 11 and 14, the control circuitry 302 determines whether the frequency of the BCI is above a threshold. (Block 1414). The control circuitry 302 may obtain BCI frequency data through any suitable technique. In some examples, the threshold of block 1416 is a pre-determined value that is set based on the frequency of data transmission.

If the frequency of the BCI is not above the threshold (Block 1414: No), the control circuitry 302 powers the buffer circuitry 429 to limit EMI generation. (Block 1416). In such examples, the control circuitry 302 powers the buffer circuitry 429 by closing switch 1102, thereby connecting the supply terminal of the amplifier circuitry 434 to the V_DD terminal 400 as described above in connection with FIG. 11. The buffer circuitry 429 produces a voltage of (V_DD/2) at a terminal connected to the resistors 430 and 432, thereby causing a voltage imbalance and an amount of current to flow through the 430 and 432. Because the resistors 430 and 432 have a specific resistance value defined above in Equation 5, the flow of current generates a voltage that counteracts the shift in V_CM, thereby mitigating the generation of EMI. In other examples, the buffer circuitry 429 is continuously powered.

If the frequency of the BCI is above the threshold (Block 1414: Yes), the diode pairs 402, 404 and 418, 420 maintain the value of V_SRC needed to use the full H-bridge. (Block 1418). The configuration of the diode pair counteracts an error caused by high frequency BCI where the driver circuitry 412 and/or 424 are unable to respond to input signals from the control circuitry 302. The machine-readable instructions and operations 1400 end after block 1416.

In the example of FIG. 14, blocks 1414-1418 are shown after blocks 1408-1412. In other examples, the control circuitry 302 may implement blocks 1414-1418 in parallel with blocks 1408-1412. That is, as the BCI current of block 1408 continues to oscillate and change from a positive value to a negative value, the control circuitry 302 may continue to power the buffer circuitry 429 whenever the BCI frequency is below the threshold of block 1414. Similarly, the diode pairs 402, 404, and 418, 420 may maintain the value of V_SRC throughout the period where the transmitter circuitry 306 operates in saturation mode, even though the error that the diode pairs correct (e.g., the value of V_SRC decreasing) occurs due to the BCI frequency being above the frequency of block 1414.

Notably, changes in the magnitude and frequency of environmental BCI cause the transmitter circuitry 306 to transition between linear mode and saturation mode independently of the control circuitry 302. Such an automatic transition reduces complexity because the control circuitry 302 does not need to change the value of input signals based on the state of the environmental noise. For example, to set V_COMHP>V_COMHN, the control circuitry 302 will turn transistors 414 and 454 ON while keeping transistors 426 and 444 OFF, regardless of whether the transmitter circuitry 306 is currently operating in block 1406, 1410, or 1412. Accordingly, blocks 1404 and 1408 of FIG. 11 do not represent active decisions being made by the control circuitry 302, but instead reflect changes in environmental BCI that may occur for any reason. Furthermore, in examples where switch 1102 is implemented, block 1404 reflects an active decision made by the control circuitry 302. But in other examples, the buffer circuitry 429 is continuously powered and block 1404 instead represents random changes in environmental BCI.

FIG. 15 is a block diagram of an example programmable circuitry platform 1500 structured to execute and/or instantiate the example machine-readable instructions and operations of FIG. 14 to implement the control circuitry 302 and transmitter circuitry 306 of FIG. 3. The programmable circuitry platform 1500 can be, for example, the battery module PCB 206A, or any other type of electronic device.

The programmable circuitry platform 1500 of the illustrated example includes programmable circuitry 1512. The programmable circuitry 1512 of the illustrated example is hardware. For example, the programmable circuitry 1512 can be implemented by one or more integrated circuits, logic circuits, FPGAs, microprocessors, CPUs, GPUs, DSPs, or microcontrollers from any desired family or manufacturer. The programmable circuitry 1512 may be implemented by one or more semiconductor based (e.g., silicon based) devices. In this example, the programmable circuitry 1512 implements the control circuitry 302.

The programmable circuitry 1512 of the illustrated example includes a local memory 1513 (e.g., a cache, registers, etc.). The programmable circuitry 1512 of the illustrated example is in communication with main memory 1514, 1516, which includes a volatile memory 1514 and a non-volatile memory 1516, by a bus 1518. The volatile memory 1514 may be implemented by Synchronous Dynamic Random Access Memory (SDRAM), Dynamic Random Access Memory (DRAM), RAMBUS® Dynamic Random Access Memory (RDRAM®), or any other type of RAM device. The non-volatile memory 1516 may be implemented by flash memory or any other desired type of memory device. Access to the main memory 1514, 1516 of the illustrated example is controlled by a memory controller 1517. In some examples, the memory controller 1517 may be implemented by one or more integrated circuits, logic circuits, microcontrollers from any desired family or manufacturer, or any other type of circuitry to manage the flow of data going to and from the main memory 1514, 1516.

The programmable circuitry platform 1500 of the illustrated example also includes interface circuitry 1520. The interface circuitry 1520 may be implemented by hardware consistent with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 1520 implements the battery interface circuitry 304, the transmitter circuitry 306, the receiver circuitry 308, the COMHP terminal 310, the COMHN terminal 312, the termination circuitry 313, and the capacitors 318.

In the illustrated example, one or more input devices 1522 are connected to the interface circuitry 1520. The input device(s) 1522 permit(s) a user (e.g., a human user, a machine user, etc.) to enter data and/or commands into the programmable circuitry 1512.

One or more output devices 1524 are also connected to the interface circuitry 1520 of the illustrated example. The interface circuitry 1520 of the illustrated example, thus, may include a graphics driver card, a graphics driver chip, and/or graphics processor circuitry such as a GPU.

The interface circuitry 1520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1500 of the illustrated example also includes one or more mass storage discs or devices 1528 to store firmware, software, and/or data. Examples of such mass storage discs or devices 1528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1532, which may be implemented by the machine-readable instructions of FIG. 14, may be stored in the mass storage device 1528, in the volatile memory 1514, in the non-volatile memory 1516, and/or on at least one non-transitory computer readable storage medium such as a CD or DVD which may be removable.

While an example manner of implementing the control circuitry 302 and transmitter circuitry 306 of FIG. 1 is illustrated in FIG. 3, one or more of the elements, processes, and/or devices illustrated in FIG. 3 may be combined, divided, re-arranged, omitted, eliminated, and/or implemented in any other way. Further, the control circuitry 302 of FIG. 3 may be implemented by hardware alone or by hardware in combination with software and/or firmware. Thus, for example the control circuitry 302 could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example control circuitry 302 and transmitter circuitry 306 of FIG. 3 may include one or more elements, processes, and/or devices in addition to, or instead of, those illustrated in FIG. 3, and/or may include more than one of any or all of the illustrated elements, processes and devices.

A flowchart representative of example machine-readable instructions, which may be executed by programmable circuitry to implement and/or instantiate the control circuitry 302 and transmitter circuitry 306 of FIG. 3 and/or representative of example operations which may be performed by programmable circuitry to implement and/or instantiate the control circuitry 302 and transmitter circuitry 306 of FIG. 3, are shown in FIG. 14. The machine-readable instructions may be one or more executable programs or portion(s) of one or more executable programs for execution by programmable circuitry such as the programmable circuitry 1512 shown in the example programmable circuitry platform 1500 described below in connection with FIG. 15 and/or may be one or more function(s) or portion(s) of functions to be performed by the example programmable circuitry (e.g., an FPGA). In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 14, many other methods of implementing the example control circuitry 302 and transmitter circuitry 306 may alternatively be used. For example, the order of execution of the blocks of the flowchart(s) may be changed, and/or some of the blocks described may be changed, eliminated, or combined. Any or all of the blocks of the flow chart may be implemented by one or more hardware circuits (e.g., processor circuitry, discrete and/or integrated analog and/or digital circuitry, an FPGA, an ASIC, an amplifier, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, such that the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 14 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (4) C alone, (4) A with B, (5) A with C, (6) B with C, or (7) A with B and with C. As used herein in the context of describing structures, components, items, objects and/or things, the phrase “at least one of A and B” refers to implementations including any of (1) at least one A, (2) at least one B, or (4) at least one A and at least one B. Similarly, as used herein in the context of describing structures, components, items, objects and/or things, the phrase “at least one of A or B” refers to implementations including any of (1) at least one A, (2) at least one B, or (4) at least one A and at least one B. As used herein in the context of describing the performance or execution of processes, instructions, actions, activities, etc., the phrase “at least one of A and B” refers to implementations including any of (1) at least one A, (2) at least one B, or (4) at least one A and at least one B. Similarly, as used herein in the context of describing the performance or execution of processes, instructions, actions, activities, etc., the phrase “at least one of A or B” refers to implementations including any of (1) at least one A, (2) at least one B, or (4) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” “fourth”, “fifth”, “sixth”, “seventh”, “eighth”, “ninth, “tenth”, etc., are used herein without imputing or otherwise indicating any meaning of priority, physical order, arrangement in a list, and/or ordering in any way, but are merely used as labels and/or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather also includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions that cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description.

Modifications are possible in the described embodiments, and other embodiments are possible, within the scope of the claims.

From the foregoing, it will be appreciated that example systems, apparatus, articles of manufacture, and methods have been described that implement a transmitter device that is galvanically isolated, can survive high amounts of BCI, and can transmit signals using both AC and DC. Described systems, apparatus, articles of manufacture, and methods improve the efficiency of using a computing device by implementing transmitter circuitry with a full H-bridge architecture that can operate in either a linear or a saturation mode. When environmental conditions provide relatively low amounts of BCI, transistors within the transmitter circuitry operate in a linear mode such that a differential signal is transmitted using Manchester Encoding. During periods with relatively high amounts of BCI, the transistors operate in a saturation mode (and connect to the output terminals in a different configuration than when in linear mode) such that differential signaling and Manchester Encoding are still supported. High magnitude BCI may occur at any frequency. Accordingly, the example transmitter circuitry includes a buffer circuitry to counteract gradual current leakage that occurs when environmental conditions cause BCI with relatively large magnitude but low frequency. The transmitter circuitry also includes diode pairs to prevent misshaped waveforms that can occur due to BCI with relatively large magnitude and high frequency. Described systems, apparatus, articles of manufacture, and methods are accordingly directed to one or more improvement(s) in the operation of a machine such as a computer or other electronic and/or mechanical device.

What is claimed is:

1. An apparatus comprising:
a first diode including an anode coupled to a supply terminal of the apparatus and a cathode coupled to a supply terminal of first pre-driver circuitry;
a second diode including a cathode coupled to the cathode of the first diode and an anode;
a first transistor including a first current terminal coupled to the supply terminal of the apparatus, a second current terminal, and a control terminal coupled to the second current terminal;
a second transistor including a first current terminal coupled to the supply terminal of the apparatus, a control terminal coupled to the control terminal of the first transistor, and a second current terminal;
a third diode including an anode coupled to the second current terminal of the second transistor and a cathode coupled to the anode of the second diode;
a third transistor including a first current terminal coupled to the anode of the second diode, a control terminal coupled to an output terminal of first driver circuitry, and a second current terminal coupled to a first communication terminal;
a fourth diode including an anode coupled to the supply terminal of the apparatus and a cathode coupled to an output terminal of second pre-driver circuitry;
a fifth diode including a cathode coupled to the cathode of the fifth diode and an anode;
a sixth diode including an anode coupled to the second current terminal of the second transistor and a cathode coupled to the anode of the sixth diode;
a fourth transistor including a first current terminal coupled to the anode of the sixth diode, a control terminal coupled to the output terminal of second driver circuitry, and a second current terminal coupled to a second communication terminal;
a first resistor including a first terminal coupled to the second communication terminal and a second terminal;
a second resistor including a second terminal coupled to the first communication terminal and a second terminal coupled to the second terminal of the first resistor;
amplifier circuitry including a first input terminal configured to receive a nominal common mode voltage; a second input terminal; and an output terminal coupled to both the second input terminal of the amplifier circuitry and the second terminal of the first resistor;
a fifth transistor including a second current terminal coupled to the first communication terminal; a control terminal; and a first current terminal coupled to the control terminal of the fifth transistor;
a sixth transistor including a second current terminal coupled to the first current terminal of the fifth transistor, a control terminal coupled to an output terminal of third driver circuitry, and a first current terminal;
a seventh transistor including a second current terminal coupled to the second communication terminal, a control terminal, and a first current terminal coupled to the control terminal of the seventh transistor;
an eighth transistor including a second current terminal coupled to the first current terminal of the seventh transistor, a control terminal coupled to an output of fourth driver circuitry, and a first current terminal;
a ninth transistor including a second current terminal coupled to the first current terminal of the sixth transistor and the first current terminal of the eighth transistor, a control terminal, and a first current terminal configured to be coupled to ground; and
a tenth transistor including a first current terminal coupled to the second current terminal of the first transistor, a control terminal coupled to the second current terminal of the first transistor and to the control terminal of the ninth transistor, and a first current terminal configured to be coupled to ground.

2. The apparatus of claim 1, wherein the first pre-driver circuitry, the second pre-driver circuitry, third pre-driver circuitry, and fourth pre-driver circuitry are configured to receive input signals such that a voltage at the first communication terminal and a voltage at the second communication terminal collectively form a differential output signal.

3. The apparatus of claim 2, wherein the first diode and the second diode are configured to maintain the differential output signal when the apparatus is exposed to high frequency bulk current injection (BCI).

4. The apparatus of claim 3, wherein the first diode and the second diode are configured to mitigate a decrease in voltage at the supply terminal of the first pre-driver circuitry, the decrease in voltage caused by the high frequency BCI.

5. The apparatus of claim 2, wherein the amplifier circuitry is configured to maintain the differential output signal when the apparatus is exposed to low frequency bulk current injection (BCI).

6. The apparatus of claim 5, wherein:
the low frequency BCI causes an external capacitor to discharge over time, the external capacitor coupled to a first terminal of an external resistor, the external resistor having a second terminal coupled to the first resistor of the apparatus; and
the amplifier circuitry is configured to generate a voltage imbalance between the first terminal of the first resistor and the second terminal of the first resistor, the voltage imbalance to cause a flow of current that recharges the external capacitor.

7. The apparatus of claim 6, wherein the resistance of the first resistor is a pre-determined value based on a performance requirement describing an allowable shift in common mode voltage.

8. The apparatus of claim 2, wherein:
the third transistor, fourth transistor, sixth transistor, and eighth transistor collectively form a full H-bridge:
the full H-bridge is configured to:
transmit, in response to a magnitude of bulk current injection (BCI) exposed to the apparatus being below a threshold value, the differential output signal by switching between a first configuration and a second configuration; and
transmit, in response to the magnitude of BCI exposed to the apparatus being above a threshold value, the differential output signal by switching between a third configuration, a fourth configuration, a fifth configuration, and a sixth configuration, wherein the first configuration, the second configuration, the third configuration, the fourth configuration, the fifth configuration, and the sixth configuration are different from one another.

9. The apparatus of claim 8, wherein the second transistor and the ninth transistor are configured to:
operate in a linear mode when the apparatus operates in the first configuration or the second configuration; and
operate in a saturation mode when the apparatus operates in the third configuration, the fourth configuration, the fifth configuration, or the sixth configuration.

10. The apparatus of claim 9, wherein the differential output signal is formatted with Manchester Encoding during both the linear mode and the saturation mode.

11. The apparatus of claim 2, wherein the apparatus is configured to transmit the differential output signal using an Alternating Current (AC) coupling to an external device, the apparatus and an external device connected to the apparatus having ground planes at different voltages.

12. A system comprising:
a first device having a ground plane at a first voltage, a first transmission terminal, and a second transmission terminal;
a second device having a ground plane at a second voltage, a first receiver terminal, and a second receiver terminal;
a first capacitor coupled to the first transmission terminal of the first device and the first receiver terminal of the second device;
a second capacitor coupled to the second transmission terminal of the first device and the second receiver terminal of the second device;
wherein the first device is configured to:
operate in either a linear mode or a saturation mode based on a magnitude of electromagnetic interference; and
during the linear mode or the saturation mode, use the first transmission terminal and second transmission terminal to transmit a differential signal to the second device.

13. The system of claim 12, wherein the first device includes:
a first diode including an anode coupled to a supply terminal of the first device and a cathode coupled to a supply terminal of first pre-driver circuitry;
a second diode including a cathode coupled to the cathode of the first diode and an anode;
a first transistor including a first current terminal coupled to the supply terminal of the first device, a second current terminal, and a control terminal coupled to the second current terminal;
a second transistor including a first current terminal coupled to the supply terminal of the first device, a control terminal coupled to the control terminal of the first transistor, and a second current terminal;
a third diode including an anode coupled to the second current terminal of the second transistor and a cathode coupled to the anode of the second diode;
a third transistor including a first current terminal coupled to the anode of the second diode, a control terminal coupled to an output terminal of first driver circuitry, and a second current terminal coupled to a first communication terminal;
a fourth diode including an anode coupled to the supply terminal of the first device and a cathode coupled to an output terminal of second pre-driver circuitry;
a fifth diode including a cathode coupled to the cathode of the fifth diode and an anode;
a sixth diode including an anode coupled to the second current terminal of the second transistor and a cathode coupled to the anode of the sixth diode;
a fourth transistor including a first current terminal coupled to the anode of the sixth diode, a control terminal coupled to the output terminal of second driver circuitry, and a second current terminal coupled to a second communication terminal;
a first resistor including a first terminal coupled to the second communication terminal and a second terminal;
a second resistor including a second terminal coupled to the first communication terminal and a second terminal coupled to the second terminal of the first resistor;
amplifier circuitry including a first input terminal configured to receive a nominal common mode voltage; a second input terminal; and an output terminal coupled to both the second input terminal of the amplifier circuitry and the second terminal of the first resistor;
a fifth transistor including a second current terminal coupled to the first communication terminal; a control terminal; and a first current terminal coupled to the control terminal of the fifth transistor;
a sixth transistor including a second current terminal coupled to the first current terminal of the fifth transistor, a control terminal coupled to an output terminal of third driver circuitry, and a first current terminal;
a seventh transistor including a second current terminal coupled to the second communication terminal, a control terminal, and a first current terminal coupled to the control terminal of the seventh transistor;
an eighth transistor including a second current terminal coupled to the first current terminal of the seventh transistor, a control terminal coupled to an output of fourth driver circuitry, and a first current terminal;
a ninth transistor including a second current terminal coupled to the first current terminal of the sixth transistor and the first current terminal of the eighth transistor, a control terminal, and a first current terminal configured to be coupled to ground; and
a tenth transistor including a first current terminal coupled to the second current terminal of the first transistor, a control terminal coupled to the second current terminal of the first transistor and to the control terminal of the ninth transistor, and a first current terminal configured to be coupled to ground.

14. The system of claim 13, wherein responsive to the first device being exposed to high frequency bulk current injection (BCI) caused by the electromagnetic interference:
the first device operates in the saturation mode; and
the first diode and the second diode are configured to maintain the differential signal by mitigating a decrease in voltage at the supply terminal of the first pre-driver circuitry, the decrease in voltage caused by the high frequency BCI.

15. The system of claim 13, wherein responsive to the first device being exposed to low frequency bulk current injection (BCI) caused by the electromagnetic interference:
the first device operates in the saturation mode;
the low frequency BCI causes an external capacitor to discharge over time, the external capacitor coupled to a first terminal of an external resistor, the external resistor having a second terminal coupled to the first resistor of the first device; and
the amplifier circuitry is configured to generate a voltage imbalance between the first terminal of the first resistor and the second terminal of the first resistor, the voltage imbalance to cause a flow of current that recharges the external capacitor.

16. The system of claim 15, wherein the resistance of the first resistor is a pre-determined value based on a performance requirement describing an allowable shift in common mode voltage.

17. The system of claim 13, wherein:
the third transistor, fourth transistor, sixth transistor, and eighth transistor collectively form a full H-bridge:
the full H-bridge is configured to:
transmit, in response to a magnitude of bulk current injection (BCI) exposed to the first device being below a threshold value, the differential signal by switching between a first configuration and a second configuration; and
transmit, in response to the magnitude of BCI exposed to the first device being above a threshold value, the differential signal by switching between a third configuration, a fourth configuration, a fifth configuration, and a sixth configuration, wherein the first configuration, the second configuration, the third configuration, the fourth configuration, the fifth configuration, and the sixth configuration are different from one another.

18. The system of claim 12, wherein the differential signal is formatted with Manchester Encoding during both the linear mode and the saturation mode.

19. A system comprising:
a plurality of battery cells;
a first device connected to a first subset of the battery cells, the first device including a first transmission terminal and a second transmission terminal;
a second device connected to a second subset of battery cells, the second subset of battery cells having a different voltage than the first subset of battery cells, the second device including a first receiver terminal and a second receiver terminal;
wherein the first device is configured to:
operate in either a linear mode or a saturation mode based on a magnitude of electromagnetic interference; and
during the linear mode or the saturation mode, use the first transmission terminal and second transmission terminal to transmit a differential signal to the second device.

20. The system of claim 19, wherein the first device includes:
a first diode including an anode coupled to a supply terminal of the first device and a cathode coupled to a supply terminal of first pre-driver circuitry;
a second diode including a cathode coupled to the cathode of the first diode and an anode;
a first transistor including a first current terminal coupled to the supply terminal of the first device, a second current terminal, and a control terminal coupled to the second current terminal;
a second transistor including a first current terminal coupled to the supply terminal of the first device, a control terminal coupled to the control terminal of the first transistor, and a second current terminal;
a third diode including an anode coupled to the second current terminal of the second transistor and a cathode coupled to the anode of the second diode;
a third transistor including a first current terminal coupled to the anode of the second diode, a control terminal coupled to an output terminal of first driver circuitry, and a second current terminal coupled to a first communication terminal;
a fourth diode including an anode coupled to the supply terminal of the first device and a cathode coupled to an output terminal of second pre-driver circuitry;
a fifth diode including a cathode coupled to the cathode of the fifth diode and an anode;
a sixth diode including an anode coupled to the second current terminal of the second transistor and a cathode coupled to the anode of the sixth diode;
a fourth transistor including a first current terminal coupled to the anode of the sixth diode, a control terminal coupled to the output terminal of second driver circuitry, and a second current terminal coupled to a second communication terminal;
a first resistor including a first terminal coupled to the second communication terminal and a second terminal;
a second resistor including a second terminal coupled to the first communication terminal and a second terminal coupled to the second terminal of the first resistor;
amplifier circuitry including a first input terminal configured to receive a nominal common mode voltage; a second input terminal; and an output terminal coupled to both the second input terminal of the amplifier circuitry and the second terminal of the first resistor;
a fifth transistor including a second current terminal coupled to the first communication terminal; a control terminal; and a first current terminal coupled to the control terminal of the fifth transistor;
a sixth transistor including a second current terminal coupled to the first current terminal of the fifth transistor, a control terminal coupled to an output terminal of third driver circuitry, and a first current terminal;
a seventh transistor including a second current terminal coupled to the second communication terminal, a control terminal, and a first current terminal coupled to the control terminal of the seventh transistor;
an eighth transistor including a second current terminal coupled to the first current terminal of the seventh transistor, a control terminal coupled to an output of fourth driver circuitry, and a first current terminal;
a ninth transistor including a second current terminal coupled to the first current terminal of the sixth transistor and the first current terminal of the eighth transistor, a control terminal, and a first current terminal configured to be coupled to ground; and
a tenth transistor including a first current terminal coupled to the second current terminal of the first transistor, a control terminal coupled to the second current terminal of the first transistor and to the control terminal of the ninth transistor, and a first current terminal configured to be coupled to ground.
